(19) United States
(12) Patent Application Publication
(10) Pub. No.: US 2025/0150996 A1
(43) Pub. Date: May 8, 2025

(54) WIRELESS COMMUNICATION DEVICE, WIRELESS COMMUNICATION METHOD, AND PROGRAM

(71) Applicant: SONY GROUP CORPORATION, TOKYO (JP)

(72) Inventors: YUSUKE TANAKA, TOKYO (JP); KAZUYUKI SHIMEZAWA, TOKYO (JP); HIROMASA UCHIYAMA, TOKYO (JP)

(21) Appl. No.: 18/709,122

(22) PCT Filed: Nov. 4, 2022
(86) PCT No.: PCT/JP2022/041122

§ 371 Date: May 10, 2024

(30) Foreign Application Priority Data
Nov. 18, 2021 (JP) 2021-187763

(51) Int. Cl. H04W 56/00; H04W 72/0446; H04W 72/0453; H04W 84/12

(52) U.S. Cl. CPC H04W 56/0015; H04W 72/0446; H04W 72/0453; H04W 84/12

(57) ABSTRACT

The present technology relates to a wireless communication device, a wireless communication method, and a program, in which communication collisions with different communication systems can be reduced. The wireless communication device acquires information regarding a communication resource usable by the wireless communication device, the information being determined on the basis of transmission information transmitted from another first wireless communication device of another bidirectional second communication system different from a first communication system of the wireless communication device. The present technology can be applied to a wireless communication system including two different bidirectional communication systems.

### TECHNICAL FIELD

The present technology relates to a wireless communication device, a wireless communication method, and a program, and particularly relates to a wireless communication device, a wireless communication method, and a program, in which communication collisions with different communication systems can be reduced.

### BACKGROUND ART

With the expansion of use applications of the wireless communication, it is required to flexibly cope with various indexes such as frequency efficiency, transmission rate, and latency. Since a wireless local area network (WLAN) widely used in an unlicensed band is for autonomous distributed wireless communication, it is difficult to optimize these indexes from the viewpoint of the entire system.

The WLAN is also referred to as a wireless LAN, and is a communication scheme for a LAN built using wireless communication. As the communication scheme of WLAN, for example, there is a communication scheme based on the IEEE 802.11 standard, and Wi-Fi (registered trademark) is a name related to a wireless LAN using the standard.

On the other hand, there is a cellular communication system. The cellular communication system is a mobile communication system, and more specifically, is a system that performs communication using a communication scheme conforming to the 3GPP (registered trademark) standard or the ETSI standard.

Long Term Evolution (LTE) and New Radio (NR), which are cellular communication systems, are centralized wireless communication, and thus can optimize the indexes from the viewpoint of the entire system. In general, LTE and NR are communication in a licensed band, but standards such as a license-assisted access (LAA) and new radio-unlicensed (NR-U) assuming operation in the unlicensed band are set, and the integrated operation with WLAN is expected in the unlicensed band in the future.

Patent Document 1 describes a system that performs communication based on LTE-WLAN aggregation (LWA) which is a cooperative communication technology between LAA and WLAN.

### CITATION LIST

### Patent Document

Patent Document 1: Japanese Patent Application Laid-Open No. 2020-102890

### SUMMARY OF THE INVENTION

### Problems to be Solved by the Invention

In LTE and NR, on the basis of a system frame including time and frequency resources, a base station (next Generation NodeB (gNB)) performs resource allocation for optimizing an index of each communication.

However, the communication system is different from LTE and NR, and an AP which is a base station of a WLAN which is of an autonomous distributed type and an STA which is a terminal do not grasp a system frame as a reference, and there is no method for knowing the allocation of resources determined by a gNB. Furthermore, since the allocation of resources cannot be grasped, there is a possibility that the communication between LTE or NR and WLAN collides.

The present technology has been made in view of such a situation, and aims to reduce communication collisions with different communication systems.

### Solutions to Problems

According to a first aspect of the present technology, there is provided a wireless communication device including a communication control unit configured to acquire information regarding a communication resource usable by the wireless communication device, the information being determined on the basis of transmission information transmitted from another first wireless communication device of another bidirectional second communication system different from a first communication system of the wireless communication device.

According to a second aspect of the present technology, there is provided a wireless communication device including a communication control unit configured to perform control to transmit, to another wireless communication device of another bidirectional second communication system, transmission information determined on the basis of the transmission information transmitted from a first communication system of the wireless communication device, the transmission information including information regarding a communication resource usable by the another wireless communication device of the second communication system.

In the first aspect of the present technology, information regarding a communication resource usable by the wireless communication device is acquired, the information being determined on the basis of transmission information transmitted from another first wireless communication device of another bidirectional second communication system different from a first communication system of the wireless communication device.

In the second aspect of the present technology, control is performed to transmit, to another wireless communication device of another bidirectional second communication system, transmission information determined on the basis of the transmission information transmitted from a first communication system of the wireless communication device, the transmission information including information regarding a communication resource usable by the another wireless communication device of the second communication system.

### BRIEF DESCRIPTION OF DRAWINGS

FIG. 1 is a diagram illustrating a configuration example of a wireless communication system according to an embodiment of the present technology.

FIG. 2 is a block diagram illustrating a configuration example of a wireless communication device.

FIG. 3 is a diagram illustrating a mode of a first combination of devices in a wireless communication system.

FIG. 4 is a sequence diagram illustrating processing of the first combination of FIG. 3.

FIG. 5 is a diagram illustrating a mode of a second combination of devices in a wireless communication system.

FIG. 6 is a sequence diagram illustrating processing of the second combination of FIG. 5.

FIG. 7 is a diagram illustrating a mode of a third combination of devices in a wireless communication system.

FIG. 8 is a sequence diagram illustrating processing of the third combination of FIG. 7.

FIG. 9 is a diagram illustrating a mode of a fourth combination of devices in a wireless communication system.

FIG. 10 is a diagram illustrating a mode of a fifth combination of devices in a wireless communication system.

FIG. 11 is a diagram illustrating a mode of a sixth combination of devices in a wireless communication system.

FIG. 12 is a diagram schematically illustrating conversion of a signal format in an adaptation layer.

FIG. 13 is a diagram illustrating an example of resource allocation of a WLAN system and a cellular system.

FIG. 14 is a diagram illustrating examples of resources in transmission of a synchronization signal in a wireless communication system and DL transmission in a WLAN system.

FIG. 15 is a diagram illustrating examples of resources in transmission of a synchronization signal in a wireless communication system and UL transmission of a WLAN system.

FIG. 16 is a diagram illustrating an example of a frame format of a synchronization signal in a WLAN signal format.

FIG. 17 is a sequence diagram illustrating mutual detection processing and connection establishment processing of a gNB and a new AP.

FIG. 18 is a block diagram illustrating a configuration example of a computer.

FIG. 19 is a block diagram illustrating a schematic configuration example of a smartphone to which the present technology is applied.

FIG. 20 is a block diagram illustrating a schematic configuration example of an in-vehicle device to which the present technology is applied.

FIG. 21 is a block diagram illustrating a schematic configuration example of a wireless AP to which the present technology is applied.

### MODE FOR CARRYING OUT THE INVENTION

Hereinafter, a mode for carrying out the present technology is described. The description will be given in the following order.
1. Configurations of system and device
2. Combination of devices in system
3. Embodiment (detailed)
4. Others

### 1. Configurations of System and Device

### <Configuration of Wireless Communication System>

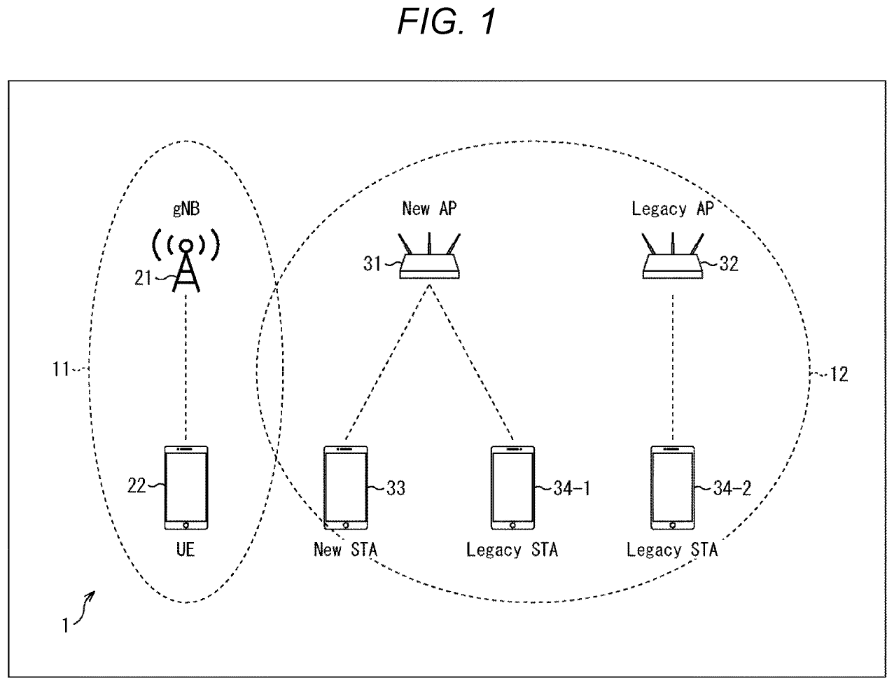

FIG. 1 is a diagram illustrating a configuration example of a wireless communication system according to an embodiment of the present technology.

A wireless communication system 1 of FIG. 1 includes a cellular system 11 and a WLAN system 12.

The cellular system 11 is a bidirectional communication system that performs centralized control communication, and performs at least one of slotted communication and time slice communication.

The cellular system 11 includes a gNB 21 that is a wireless communication device operating as a base station and a user equipment (UE) 22 that is a wireless communication device operating as a terminal.

The WLAN system 12 is an autonomous distributed bidirectional communication system, and performs communication in an event-driven manner.

The WLAN system 12 includes a new AP 31 and a legacy AP 32 that are wireless communication devices operating as base stations, and a new STA 33 and a legacy STA 34 that are wireless communication devices operating as terminals.

The new AP 31 and the new STA 33 are respectively an AP and a STA having the functions of the present technology. The legacy AP 32 and the legacy STA 34 are respectively the existing AP and STA that do not have functions of the present technology.

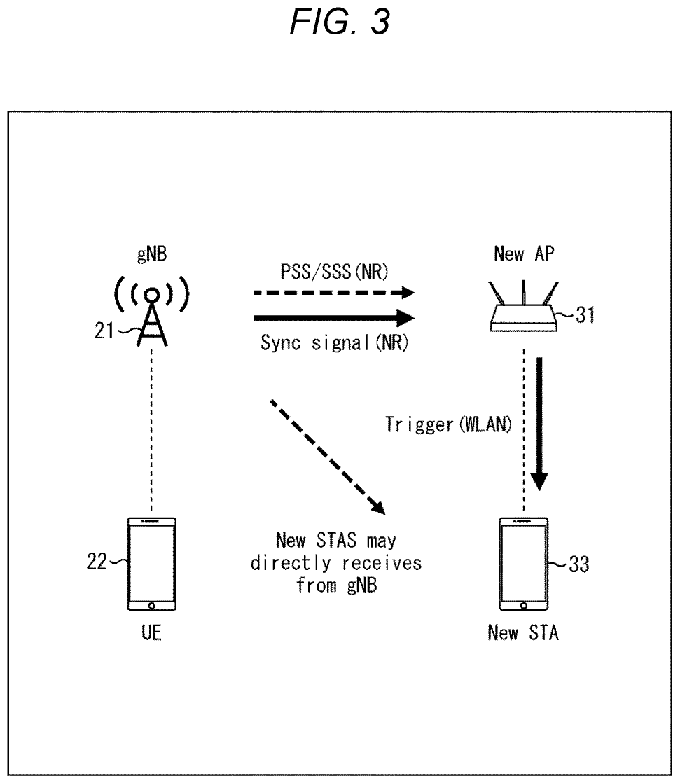

Note that this configuration is not limited thereto, and there may be a plurality of configurations of a combination of wireless communication devices. Details of communication in each combination will be described later with reference to FIG. 3 and subsequent drawings.

FIG. 1 illustrates an example in which the cellular system 11 is NR and the base station is a gNB, but the present technology can also be applied to a case where the cellular system 11 is LTE and the base station is an evolved Node B (eNB). Note that the synchronization signal in this case is a signal in an LTE format (synchronization signal defined in the LTE standard).

### Configuration Example of Wireless Communication Device

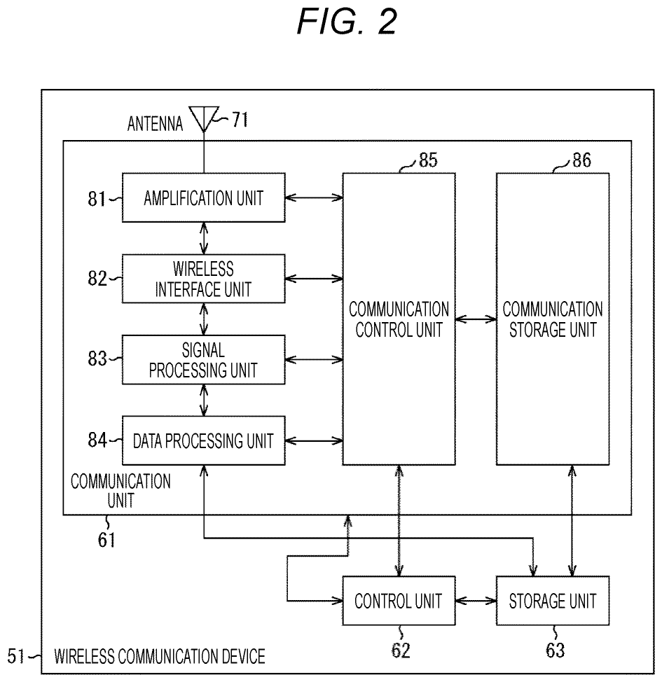

FIG. 2 is a block diagram illustrating a configuration example of the wireless communication device.

A wireless communication device 51 illustrated in FIG. 2 is a wireless communication device that operates as an AP or an STA of the WLAN system 12.

The wireless communication device 51 includes a communication unit 61, a control unit 62, a storage unit 63, and an antenna 71.

The communication unit 61 transmits and receives data. The communication unit 61 includes an amplification unit 81, a wireless interface unit 82, a signal processing unit 83, a data processing unit 84, a communication control unit 85, and a communication storage unit 86.

At the time of transmission, the amplification unit 81 amplifies an analog signal supplied from the wireless interface unit 82 to a predetermined power, and outputs the analog signal with the amplified power to the antenna 71. At the time of reception, the amplification unit 81 amplifies an analog signal supplied from the antenna 71 to a predetermined power, and outputs the analog signal with amplified power to the wireless interface unit 82.

A part of a function of the amplification unit 81 may be included in the wireless interface unit 82. Furthermore, a part of the function of the amplification unit 81 may be a component outside the communication unit 61.

At the time of transmission, the wireless interface unit 82 converts a transmission symbol stream from the signal processing unit 83 into an analog signal, performs filtering, up-conversion to a carrier frequency, and phase control, and outputs the analog signal after the phase control to the amplification unit 81.

At the time of reception, the wireless interface unit 82 performs phase control, down-conversion, and reverse filtering on an analog signal supplied from the amplification unit 81, generates a reception symbol stream, which is the result of conversion into a digital signal, and outputs the reception symbol stream to the signal processing unit 83.

At the time of transmission, the signal processing unit 83 performs encoding, interleaving, modulation or the like on a data unit supplied from the data processing unit 84, adds a physical header to the data unit, generates a transmission symbol stream, and outputs the transmission symbol stream to the wireless interface unit 82.

At the time of reception, the signal processing unit 83 analyzes the physical header of the reception symbol stream supplied from the wireless interface unit 82, performs demodulation, deinterleaving, decoding or the like on the reception symbol stream, and generates a data unit. The generated data unit is output to the data processing unit 84.

Note that the signal processing unit 83 performs complex channel characteristic estimation processing and spatial separation processing as necessary.

At the time of transmission, the data processing unit 84 performs sequence management of data stored in the communication storage unit 86 and control information and management information received from the communication control unit 85. Furthermore, the data processing unit 84 generates a data unit by performing encryption processing or the like on the control information and the management information, and performs channel access operation based on carrier sensing, addition of a media access control (MAC) header and addition of an error detection code to data to be transmitted, and aggregation processing of a plurality of data units.

At the time of reception, the data processing unit 84 performs disassemble processing of the MAC header of the received data unit, an analysis and error detection, retransmission request operation, analysis processing of the data unit, and reorder processing.

Note that the data processing unit 84 may include an individual data processing unit that performs an operation necessary for communication in a single frequency band and a common data processing unit that is connected to a plurality of the individual data processing units and performs operation common to communication in a plurality of the frequency bands.

The communication control unit 85 controls the operation of each unit in the communication unit 61 and information transmission between the units. Furthermore, the communication control unit 85 performs control to transfer, to a data processing unit 54, control information and management information to be notified to other wireless communication devices.

Furthermore, the communication control unit 85 controls each unit to perform communication with a communication resource (hereinafter, also simply referred to as a resource) determined by the gNB 21 on the basis of the synchronization signal (first synchronization signal) of the present technology, which is transmission information transmitted from the gNB 21. In a case where the wireless communication device 51 is an AP, the communication control unit 85 further controls each unit to notify a subordinate wireless communication device (STA) or another wireless communication device (AP) of information regarding the resources.

The communication storage unit 86 holds information to be used by the communication control unit 85. Furthermore, the communication storage unit 86 holds data to be transmitted and the received data.

The control unit 62 includes a central processing unit (CPU), a read only memory (ROM), and a random access memory (RAM). The control unit 62 executes a program stored in the ROM or the like, and controls the communication unit 61 and the communication control unit 85. Furthermore, the control unit 62 may also perform the partial operation of the communication control unit 85 instead. Furthermore, the communication control unit 85 and the control unit 62 may be configured as one block.

The storage unit 63 holds information used by the communication unit 61 and the control unit 62. Furthermore, the storage unit 63 may also perform the partial operation of the communication storage unit 86 instead. The storage unit 63 and the communication storage unit 86 may be configured as one block.

Note that, in a case where antennas 71, amplification units 81, and wireless interface units 82 are provided in plural, the antennas 71, the amplification units 81, and the wireless interface units 82 may respectively form one set, and two or more sets may be components of the wireless communication device 51. Furthermore, the communication unit 61 is implemented by one or more LSIs.

The wireless communication devices operating as the gNB 21 and the UE 22 of the cellular system 11 are basically configured similarly to the wireless communication device 51 illustrated in FIG. 2.

In particular, in a case of operating as the gNB 21, the communication control unit 85 controls each unit to generate a synchronization signal of the present technology to be transmitted from the gNB 21 to an AP 31 and transmit the synchronization signal by using a predetermined resource. Furthermore, the communication control unit 85 controls each unit so that the AP generates and transmits control information necessary for receiving the synchronization signal.

### 2. Combination of Devices in System

### <First Combination>

FIG. 3 is a diagram illustrating a mode of a first combination of devices in the wireless communication system 1.

The first combination in FIG. 3 includes the gNB 21 and UE 22 of the cellular system 11 and the new AP 31 and new STA 33 of the WLAN system 12.

Note that, in the first combination, the new AP 31 can receive a signal in a signal format (hereinafter, referred to as an NR signal format) of the cellular system 11, and the gNB 21 can transmit a signal in the NR signal format.

Moreover, in the first combination, there may be the following three cases as functions of the new AP 31.

The new AP 31 in a first case can receive a synchronization signal in the NR signal format and can receive a primary synchronization signal (PSS) and a secondary synchronization signal (SSS) which are the existing synchronization signals (second synchronization signals) necessary for the operation of the cellular system 11.

The new AP 31 in a second case can receive a synchronization signal in the NR signal format and can perform time synchronization using time information from a global navigation satellite system (GNSS) by mounting a GNSS function.

The new AP 31 in a third case can receive only a synchronization signal in the NR signal format.

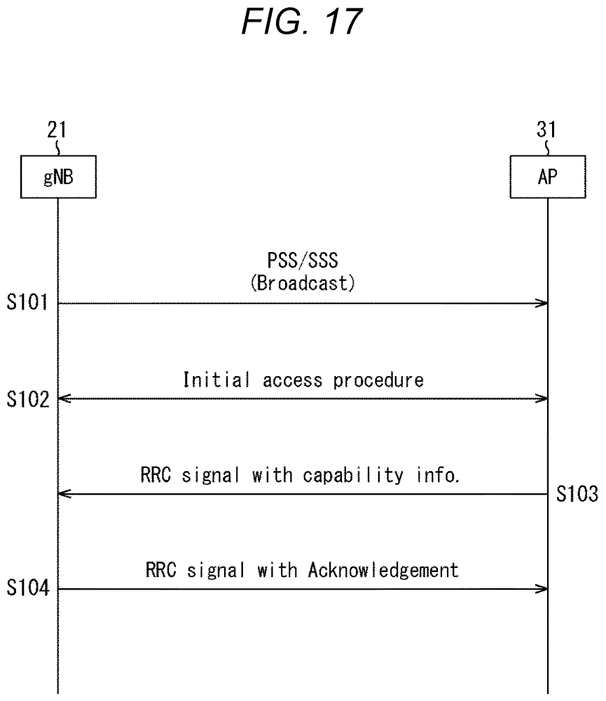

Note that the function of the new AP 31 is notified to the gNB 21 by using capability information or the like at the time of connection establishment, which will be described later with reference to FIG. 17. The gNB 21 determines the starting point or the like of the system frame on the basis of the synchronization signal of the present technology, the existing synchronization signal such as a PSS or an SSS, time information from the GNSS, and the like according to the function of the new AP 31. In the case of the synchronization signal, for example, the starting point of the system frame is determined on the basis of information described in the synchronization signal, a timing of completion of reception of the synchronization signal.

In the first combination configured as described above, the qNB 21 transmits the synchronization signal in the NR signal format, and also transmits the PSS and the SSS.

The new AP 31 receives the synchronization signal transmitted from the gNB 21. If possible, the new AP 31 also receives the PSS and SSS. The new AP 31 acquires information regarding a system frame determined by the gNB 21 and information regarding resources (hereinafter, referred to as WLAN resources) that can be used by the WLAN system 12 on the basis of the received synchronization signal.

The new AP 31 starts its own DL (Down Link) transmission or transmits an induction signal (hereinafter, referred to as a trigger signal) for inducing UL (Up Link) transmission of the subordinate new STA 33 on the basis of the acquired information. At that time, the DL transmission signal and the trigger signal can be transmitted including information regarding the WLAN resources based on the acquired information. Note that the DL transmission signal and the trigger signal may be transmitted including information regarding the system frame. This similarly applies to the subsequent combinations.

Furthermore, the trigger signal may include information indicating a WLAN communication suppression period or a WLAN communication recommendation period based on the system frame and the WLAN resources, and information indicating that the period is a period based on a notification from the gNB. Thus, the new STA 33 can more preferentially consider the period notified from the new AP 31, and can improve the communication characteristics of the entire wireless communication system 1.

The new STA 33 performs communication on the basis of the trigger signal transmitted by the new AP 31.

Note that, in a case where the synchronization signal can be directly received from the gNB 21, the new STA 33 acquires the information regarding the system frame determined by the gNB 21 and the information regarding the WLAN resources on the basis of the information included in the synchronization signal.

In this case, the new STA 33 can perform operation such as transmission based on the WLAN resources, in particular, transmission and transmission suppression, without waiting for notification from the new AP 31.

### <Processing of First Combination>

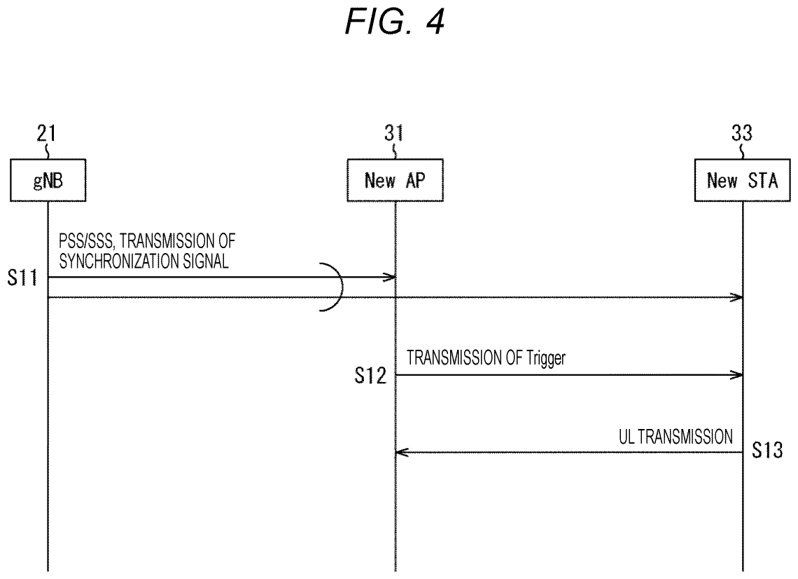

FIG. 4 is a sequence diagram illustrating processing of the first combination of FIG. 3.

In an example in FIG. 4, a UL transmission example is illustrated.

In step S11, the gNB 21 transmits the synchronization signal in the NR signal format, and also transmits the PSS and the SSS.

The new AP 31 receives the synchronization signal transmitted from the gNB 21. If possible, the new AP 31 also receives the PSS and SSS. The new AP 31 acquires information regarding the system frame determined by the gNB 21 and information regarding WLAN resources on the basis of the received synchronization signal.

In step S12, the new AP 31 transmits the trigger signal for triggering UL transmission of the subordinate new STA 33 on the basis of the acquired information.

The new STA 33 receives the trigger signal transmitted by the new AP 31.

In step S13, the new STA 33 performs the UL transmission on the basis of the received trigger signal.

### <Second Combination>

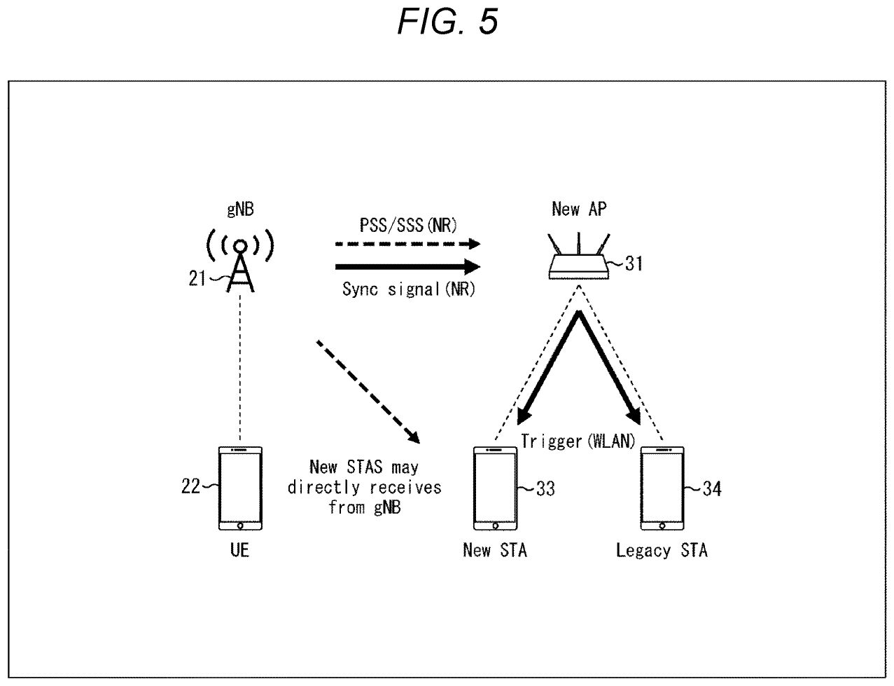

FIG. 5 is a diagram illustrating a mode of a second combination of devices in the wireless communication system 1.

The second combination in FIG. 5 includes the gNB 21 and UE 22 of the cellular system 11 and the new AP 31, new STA 33, and the legacy STA 34 of the WLAN system 12.

Note that, in the second combination, similarly to the first combination, the new AP 31 can receive a signal in the NR signal format, and the gNB 21 can transmit a signal in the NR signal format.

Moreover, in the second combination, there may be the following three cases as functions of the new AP 31, similarly to the function of the first combination.

In the second combination configured as described above, the gNB 21 transmits the synchronization signal in the NR signal format, and also transmits the PSS and the SSS.

The new AP 31 receives the synchronization signal transmitted from the gNB 21. If possible, the new AP 31 also receives the PSS and SSS. The new AP 31 acquires information regarding the system frame determined by the gNB 21 and information regarding WLAN resources on the basis of the received synchronization signal.

The new AP 31 starts its own DL transmission or transmits the trigger signal that triggers the UL transmission of the subordinate new STA 33 and legacy STA 34 on the basis of the acquired information.

Note that, as described above, the transmission of the trigger signal to the new STA 33 and the legacy STA 34 may not be performed at the same timing.

Similarly to the case of the first combination, the trigger signal to be transmitted to the new STA 33 may include information indicating a WLAN communication suppression period or a WLAN communication recommendation period based on the system frame and the WLAN resources, and information indicating that the period is a period based on a notification from the gNB.

The trigger signal transmitted to the new STA 33 and the trigger signal transmitted to the legacy STA 34 may be transmitted independently, or two trigger signals may be transmitted in combination. Furthermore, the trigger signal transmitted to the new STA 33 may be implemented by newly adding information to unused bits or fields of the trigger signal transmitted to the legacy STA 34. In this case, the trigger signal addressed to the new STA 33 and the legacy STA 34 can be made common.

The new STA 33 and the legacy STA 34 perform communication on the basis of the trigger signal transmitted by the new AP 31.

Note that, similarly to the case of the first combination, also in the second combination, in a case where the synchronization signal can be directly received from the gNB 21, the new STA 33 acquires the information regarding the system frame determined by the gNB 21 and the information regarding the WLAN resources on the basis of the information included in the synchronization signal.

Furthermore, in a case where the new STA 33 can receive the synchronization signal transmitted from the gNB 21, it is desirable that the trigger signal transmitted to the legacy STA 34 is transmitted earlier than the trigger signal transmitted to the new STA 33.

### <Processing of Second Combination>

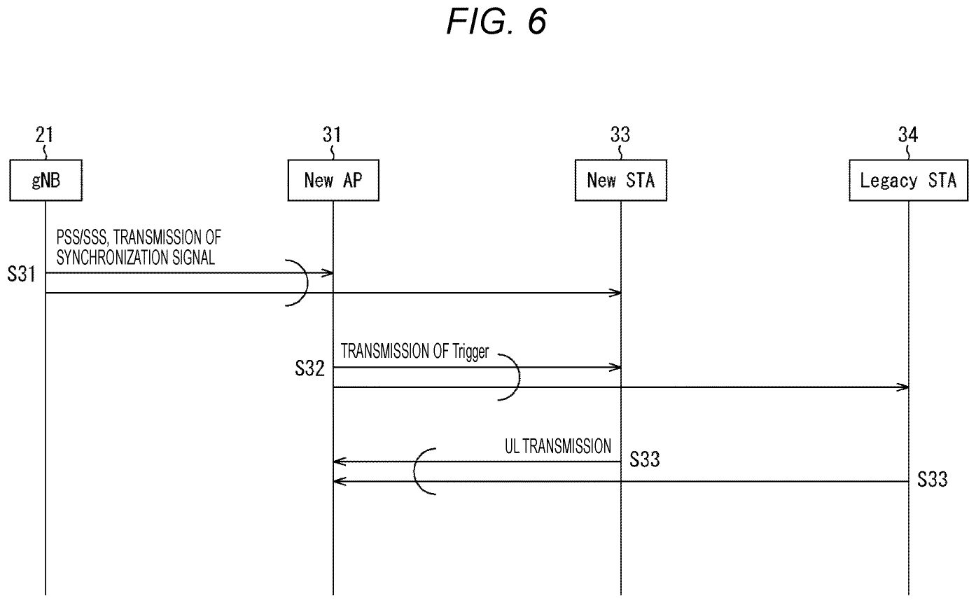

FIG. 6 is a sequence diagram illustrating processing of the second combination of FIG. 5.

In an example in FIG. 6, the UL transmission example is illustrated.

In step S31, the gNB 21 transmits the synchronization signal in the NR signal format, and also transmits the PSS and the SSS.

The new AP 31 receives the synchronization signal transmitted from the gNB 21. If possible, the new AP 31 also receives the PSS and SSS. The new AP 31 acquires information regarding the system frame determined by the gNB 21 and information regarding WLAN resources on the basis of the received synchronization signal.

In step S32, the new AP 31 transmits the trigger signal for triggering UL transmission of the subordinate new STA 33 and legacy STA 34 on the basis of the acquired information.

The new STA 33 and the legacy STA 34 receive the trigger signal transmitted by the new AP 31.

In step S33, the new STA 33 and the legacy STA 34 perform the UL transmission on the basis of the received trigger signal.

### <Third Combination>

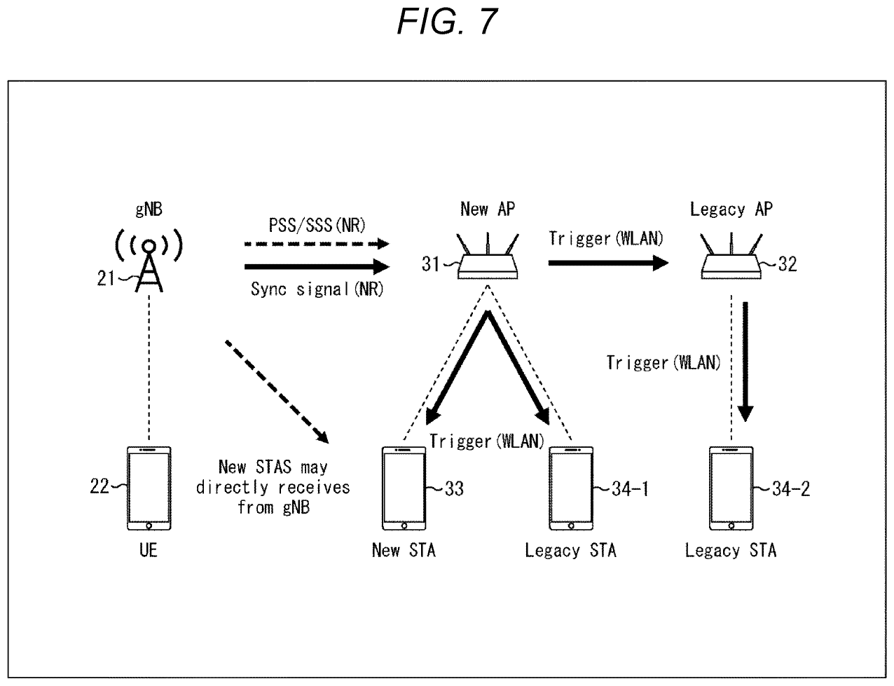

FIG. 7 is a diagram illustrating a mode of a third combination of devices in the wireless communication system 1.

The third combination in FIG. 7 includes the gNB 21 and UE 22 of the cellular system 11 and the new AP 31, legacy AP 32, and new STA 33 of the WLAN system 12, a legacy STA 34-1 and a legacy STA 34-2.

Note that, in the third combination, similarly to the first combination, the new AP 31 can receive a signal in the NR signal format, and the gNB 21 can transmit a signal in the NR signal format.

Moreover, in the third combination, there may be the following three cases as functions of the new AP 31, similarly to the function of the first combination.

In the third combination configured as described above, the qNB 21 transmits the synchronization signal in the NR signal format, and also transmits the PSS and the SSS.

The new AP 31 receives the synchronization signal transmitted from the gNB 21. If possible, the new AP 31 also receives the PSS and SSS. The new AP 31 acquires information regarding the system frame determined by the gNB 21 and information regarding WLAN resources on the basis of the received synchronization signal.

The new AP 31 starts its own DL transmission or transmits the trigger signal that triggers the UL transmission of the subordinate new STA 33 and legacy STA 34-1 on the basis of the acquired information.

Furthermore, the new AP 31 notifies another Legacy AP 32 of information indicating the WLAN communication suppression period or the WLAN communication recommendation period by using a known frame on the basis of the system frame and the WLAN resources.

Similarly to the case of the second combination, the trigger signal to be transmitted to the new STA 33 may include information indicating a WLAN communication suppression period or a WLAN communication recommendation period based on the system frame and the WLAN resources, and information indicating that the period is a period based on a notification from the gNB.

Note that, in the third combination, another AP is Legacy, but may be another new AP 31. In this case, similarly to the case of the second combination, information indicating that the WLAN communication suppression period or the WLAN communication recommendation period is a period based on the notification from the gNB 21 may be included in the notification from a transmission source new AP 31 to another new AP 31.

The legacy AP 32 controls communication of the legacy AP 32 itself and the subordinate legacy STA 34-2 on the basis of the WLAN communication suppression period or the WLAN communication recommendation period of the information received from the new AP 31.

The new STA 33 and the legacy STA 34-1 perform communication on the basis of the trigger signal transmitted by the new AP 31.

Note that, similarly to the case of the first combination, in a case where the synchronization signal can be directly received from the gNB 21, the new STA 33 acquires the information regarding the system frame determined by the gNB 21 and the information regarding the WLAN resources on the basis of the information included in the synchronization signal.

### <Processing of Third Combination>

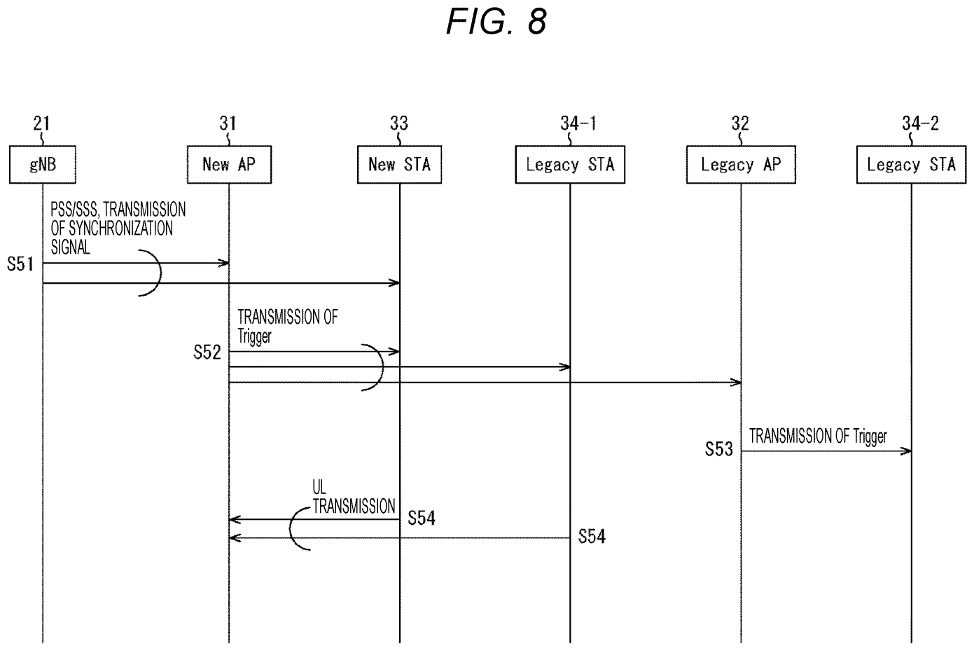

FIG. 8 is a sequence diagram illustrating processing of the third combination of FIG. 7.

In an example in FIG. 8, the UL transmission example is illustrated.

In step S51, the gNB 21 transmits the synchronization signal in the NR signal format, and also transmits the PSS and the SSS.

The new AP 31 receives the synchronization signal transmitted from the gNB 21. If possible, the new AP 31 also receives the PSS and SSS. The new AP 31 acquires information regarding the system frame determined by the gNB 21 and information regarding WLAN resources on the basis of the received synchronization signal.

In step S52, the new AP 31 transmits the trigger signal for triggering UL transmission of the subordinate new STA 33 on the basis of the acquired information.

The new STA 33, the legacy STA 34-1, and the legacy AP 32 receive the trigger signal transmitted by the new AP 31.

In step S53, the legacy AP 32 transmits the trigger signal to the subordinate legacy STA 34-2 on the basis of the received trigger signal.

In step S54, the new STA 33 and the legacy STA 34-1 performs the UL transmission on the basis of the received trigger signal.

### <Fourth Combination>

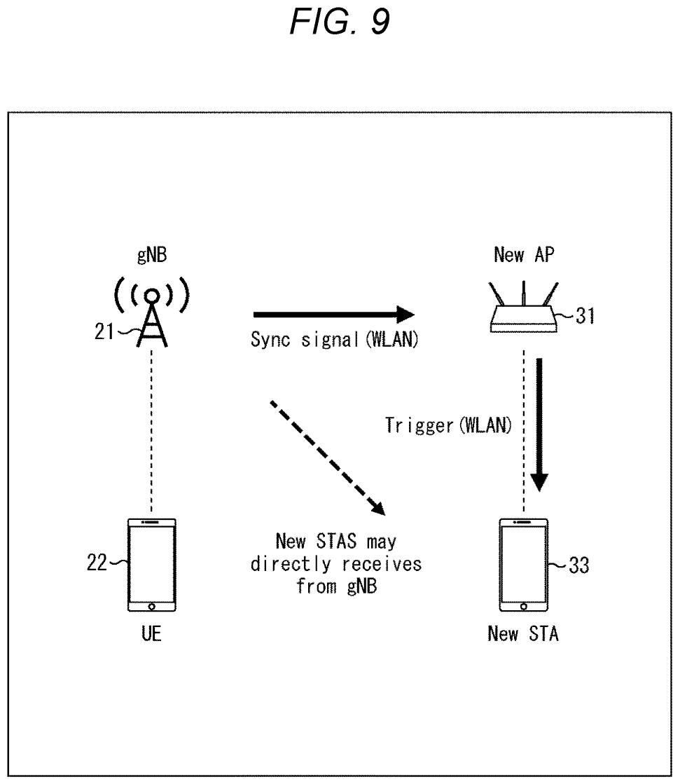

FIG. 9 is a diagram illustrating a mode of a fourth combination of devices in the wireless communication system 1. The fourth combination in FIG. 9 includes the gNB 21 and UE 22 of the cellular system 11 and the new AP 31 and new STA 33 of the WLAN system 12.

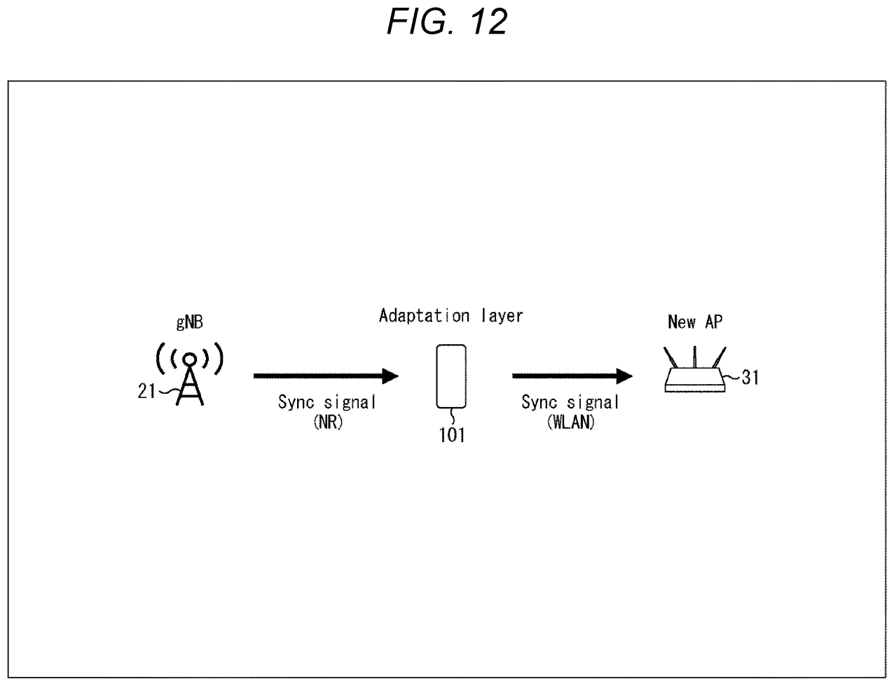

Note that, in the fourth combination, the new AP 31 cannot receive a signal in the NR signal format, and the gNB 21 can transmit a signal in a WLAN signal format. The transmission of the signal in the WLAN signal format in this case also includes a case where the signal in the WLAN signal format is transmitted via an adaptation layer to be described later with reference to FIG. 12.

Moreover, in the fourth combination, there may be the following two cases as functions of the new AP 31.

The new AP 31 in the first case can receive a synchronization signal in a signal format (hereinafter, referred to as a WLAN signal format) of the WLAN system 12, and can perform time synchronization with time information from the GNSS by mounting the GNSS.

The new AP 31 in the second case can receive only a synchronization signal in the WLAN signal format.

In the fourth combination configured as described above, the qNB 21 transmits the synchronization signal in the WLAN signal format.

The new AP 31 receives the synchronization signal transmitted from the gNB 21. The new AP 31 acquires information regarding the system frame determined by the gNB 21 and information regarding WLAN resources on the basis of the received synchronization signal.

The new AP 31 starts its own DL transmission or transmits the trigger signal for triggering the UL transmission of the subordinate new STA 33 on the basis of the acquired information.

Similarly to the case of the second combination, the trigger signal to be transmitted to the new STA 33 may include information indicating a WLAN communication suppression period or a WLAN communication recommendation period based on the system frame and the WLAN resources, and information indicating that the period is a period based on a notification from the qNB 21.

The new STA 33 performs communication on the basis of the trigger signal transmitted by the new AP 31.

Note that, similarly to the case of the first combination, in a case where the synchronization signal can be directly received from the gNB 21, the new STA 33 acquires the information regarding the system frame determined by the gNB 21 and the information regarding the WLAN resources on the basis of the information included in the synchronization signal.

Furthermore, the processing of the fourth combination is basically similar to the processing of the first combination described above in FIG. 4 except that the synchronization signal received by the new AP 31 or the new STA 33 is not in the NR signal format but in the WLAN signal format, and thus description thereof will be omitted.

### <Fifth Combination>

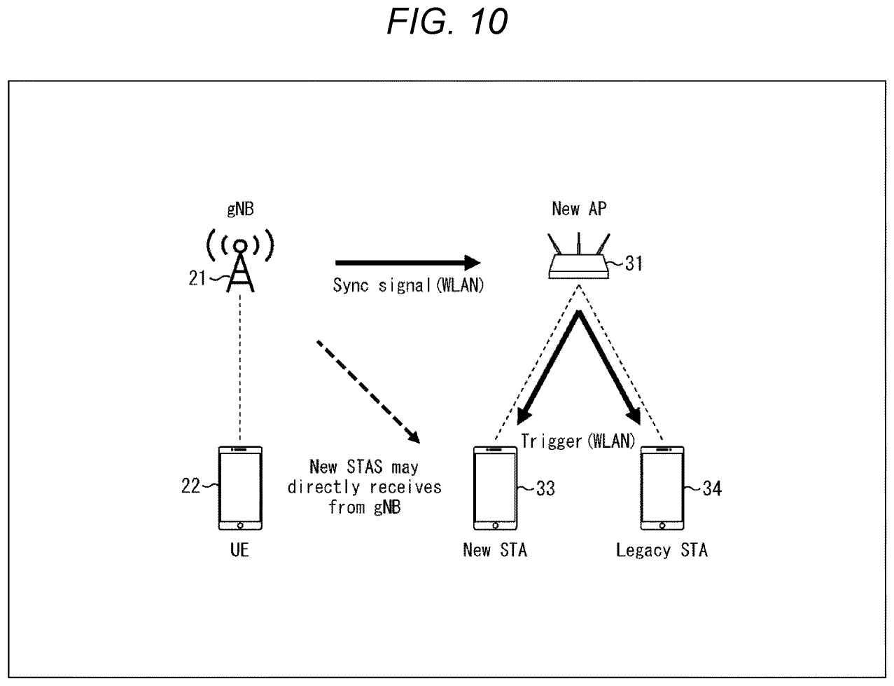

FIG. 10 is a diagram illustrating a mode of a fifth combination of devices in the wireless communication system 1.

The fifth combination in FIG. 10 includes the gNB 21 and UE 22 of the cellular system 11 and the new AP 31, new STA 33, and the legacy STA 34 of the WLAN system 12.

Note that, in the fifth combination, similarly to the fourth combination, the new AP 31 cannot receive a signal in the NR signal format, and the gNB 21 can transmit a signal in the WLAN signal format.

Moreover, in the second combination, there may be the following two cases as functions of the new AP 31, similarly to the function of the fourth combination.

In the fifth combination configured as described above, the qNB 21 transmits the synchronization signal in the WLAN signal format.

The new AP 31 receives the synchronization signal transmitted from the gNB 21. The new AP 31 acquires information regarding the system frame determined by the gNB 21 and information regarding WLAN resources on the basis of the received synchronization signal.

The new AP 31 starts its own DL transmission or transmits the trigger signal that triggers the UL transmission of the subordinate new STA 33 and legacy STA 34 on the basis of the acquired information.

Similarly to the case of the second combination, the trigger signal to be transmitted to the new STA 33 may include information indicating a WLAN communication suppression period or a WLAN communication recommendation period based on the system frame and the WLAN resources, and information indicating that the period is a period based on a notification from the gNB.

Similarly to the case of the second combination, the trigger signal transmitted to the new STA 33 and the trigger signal transmitted to the legacy STA 34 may be transmitted independently, or the two trigger signals may be transmitted in combination. Furthermore, the trigger signal transmitted to the new STA 33 may be implemented by newly adding information to unused bits or fields of the trigger signal transmitted to the legacy STA 34. In this case, the trigger signal addressed to the new STA 33 and the legacy STA 34 can be made common.

The new STA 33 and the legacy STA 34 perform communication on the basis of the trigger signal transmitted by the new AP 31.

Note that, similarly to the case of the second combination, in the fifth combination, in a case where the synchronization signal can be directly received from the gNB 21, the new STA 33 acquires the information regarding the system frame determined by the gNB 21 and the information regarding the WLAN resources on the basis of the information included in the synchronization signal.

Furthermore, the processing of the fifth combination is basically similar to the processing of the second combination described above in FIG. 6 except that the synchronization signal received by the new AP 31 or the new STA 33 is not in the NR signal format but in the WLAN signal format, and thus description thereof will be omitted.

### <Sixth Combination>

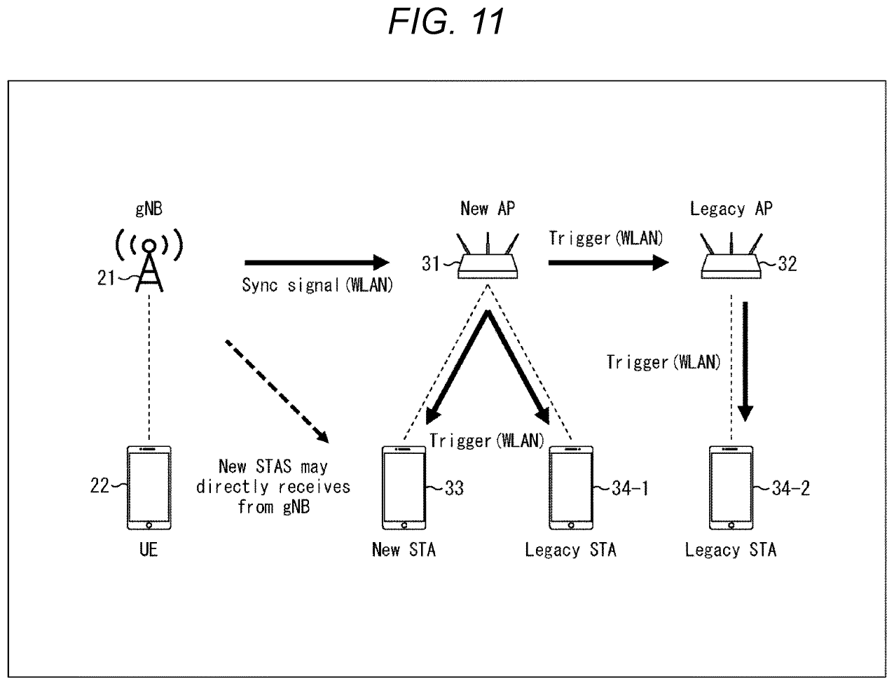

FIG. 11 is a diagram illustrating a mode of a sixth combination of devices in the wireless communication system 1.

The sixth combination in FIG. 11 includes the gNB 21 and UE 22 of the cellular system 11 and the new AP 31, legacy AP 32, and new STA 33, a legacy STA 34-1 and a legacy STA 34-2 of the WLAN system 12.

Note that, in the sixth combination, similarly to the fourth combination, the new AP 31 cannot receive a signal in the NR signal format, and the gNB 21 can transmit a signal in the WLAN signal format.

Moreover, in the sixth combination, there may be the following two cases as functions of the new AP 31, similarly to the function of the fourth combination.

In the sixth combination configured as described above, the qNB 21 transmits the synchronization signal in the WLAN signal format.

The new AP 31 receives the synchronization signal transmitted from the gNB 21. The new AP 31 acquires information regarding the system frame determined by the gNB 21 and information regarding WLAN resources on the basis of the received synchronization signal.

The new AP 31 starts its own DL transmission or transmits the trigger signal that triggers the UL transmission of the subordinate new STA 33 and legacy STA 34-1 on the basis of the acquired information.

Furthermore, the new AP 31 notifies another Legacy AP 32 of information indicating the WLAN communication suppression period or the WLAN communication recommendation period by using a known frame on the basis of the system frame and the WLAN resources.

Similarly to the case of the third combination, the trigger signal to be transmitted to the new STA 33 may include information indicating a WLAN communication suppression period or a WLAN communication recommendation period based on the system frame and the WLAN resources, and information indicating that the period is a period based on a notification from the gNB.

Note that, in the sixth combination, another AP is Legacy, but may be another new AP 31. In this case, similarly to the case of the third combination, information indicating that the WLAN communication suppression period or the WLAN communication recommendation period is a period based on the notification from the gNB may be included in the notification from a transmission source new AP 31 to another new AP 31.

The legacy AP 32 controls communication of the legacy AP 32 itself and the subordinate legacy STA 34-2 on the basis of the WLAN communication suppression period or the WLAN communication recommendation period of the information received from the new AP 31.

The new STA 33 and the legacy STA 34-1 perform communication on the basis of the trigger signal transmitted by the new AP 31.

Note that, similarly to the case of the first combination, in a case where the synchronization signal can be directly received from the gNB 21, the new STA 33 acquires the information regarding the system frame determined by the gNB 21 and the information regarding the WLAN resources on the basis of the information included in the synchronization signal.

Furthermore, the processing of the sixth combination is basically similar to the processing of the third combination described above in FIG. 8 except that the synchronization signal received by the new AP 31 or the new STA 33 is not in the NR signal format but in the WLAN signal format, and thus description thereof will be omitted.

### <Conversion of Signal Format>

FIG. 12 is a diagram schematically illustrating conversion of the signal format in the adaptation layer.

In the above-described fourth to sixth combinations, in a case where the synchronization signal in the WLAN signal format is transmitted from the gNB 21 to the new AP 31, an adaptation layer 101 between the gNB 21 and the new AP 31 may implement transmission of the synchronization signal by converting the signal format.

The adaptation layer 101 receives a synchronization signal (Sync signal) in the NR signal format transmitted from the gNB 21, converts the received synchronization signal in the NR signal format into a synchronization signal in the WLAN signal format, and transmits the synchronization signal to the new AP 31.

At this time, the adaptation layer 101 may be a part of the wireless communication device 51 operating as the gNB 21 or a part of the wireless communication device 51 operating as the new AP 31. Furthermore, the adaptation layer 101 may be configured as an independent device or a part of a device on a network or a multi-access edge computing (MEC).

### 3. Embodiment (Detailed)

### <Resource Allocation of WLAN System and NR>

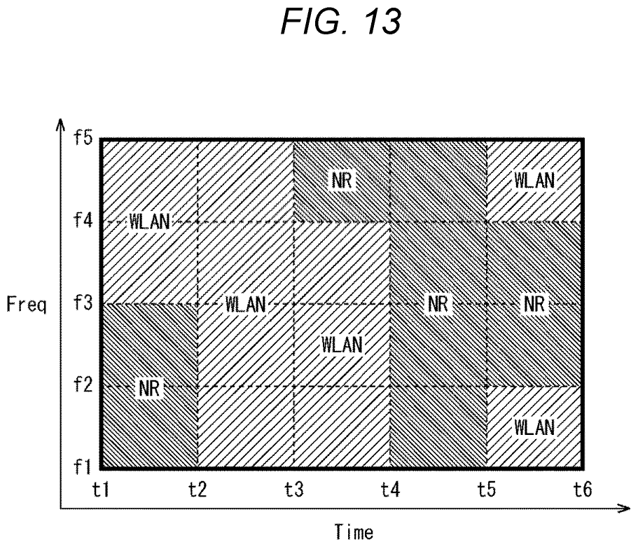

FIG. 13 is a diagram illustrating an example of resource allocation of WLAN and NR.

In the wireless communication system 1 of FIG. 1, the gNB 21 allocates some of time-frequency resources of a predetermined unlicensed band to the WLAN system 12.

FIG. 13 illustrates the resources of the system frame at frequencies f1 to f5 at time t1 to time t6 with a horizontal axis as time and a vertical axis as a frequency.

In FIG. 13, NR represents a resource allocated to the cellular system 11, and WLAN represents a resource allocated to the WLAN system 12.

That is, among the resources illustrated in FIG. 13, resources of frequencies f1 to f3 at times t1 to t2, frequencies f4 to f5 at times t3 to t4, frequencies f1 to f5 at times t4 to t5, and frequencies f2 to f4 at times t5 to t6 are allocated to the cellular system 11.

Furthermore, among the resources illustrated in FIG. 13, the resources of the frequencies f3 to f5 at times t1 to t2, the frequencies f1 to f5 at times t2 to t3, the frequencies f1 to f4 at times t3 to t4, and the frequencies f1 to f2 and the frequencies f4 to f5 at the times t5 to t6 are allocated to the WLAN system 12.

Note that, in the present description, a case where the synchronization signal includes control information for controlling resource allocation will be described. However, similarly to the synchronization signal in the NR signal format, a synchronization signal for performing symbol synchronization or frame synchronization and a control channel for notifying control information for controlling resource allocation may be transmitted, for example, by separating the channel. In this case, the synchronization signal in the description of the present technology can be replaced with a control channel or control information.

In other words, as a method of notifying the control information for the gNB to perform resource control of the WLAN system 12, a method similar to the method used in the WLAN system 12 (that is, the WLAN signal format) and a method similar to the method used in the cellular system 11 (that is, the NR signal format) can be considered. Details will be described later.

### <Transmission of Synchronization Signal and DL Transmission of WLAN>

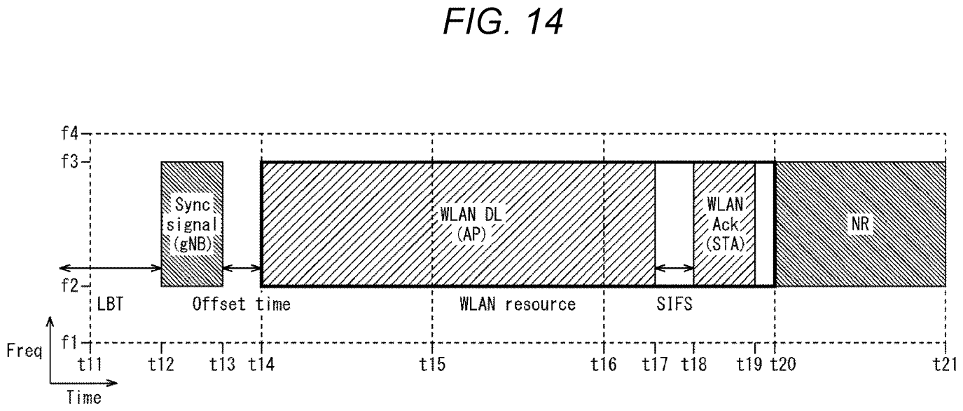

FIG. 14 is a diagram illustrating examples of resources in transmission of the synchronization signal in the wireless communication system and the DL transmission in the WLAN system 12.

In FIG. 14, a horizontal axis represents a time, a vertical axis represents a frequency, a dashed rectangle represents a resource of the system frame, and a solid rectangle represents a resource used for communication.

Note that, for convenience of description, the resources of the system frame of the frequencies f1 to f4 at times t11 to t21 are illustrated, and regarding the frequency, among the resources of the system frame, the frequencies f2 to f3 are assumed to be the resources acquired by the wireless communication system 1.

Furthermore, when a channel access right is acquired, it is assumed that the resources of times t11 to t14 and times t20 to t21 of the frequencies f2 to f3 among the resources of the system frame are allocated to the cellular system 11, and the resources of times t14 to t20 of the frequencies f2 to f3 among the resources of the system frame are allocated to the WLAN system 12. That is, the resources of the WLAN system 12 are surrounded by a thick line.

First, the gNB 21 executes listen before talk (LBT) at time t11 in FIG. 14 to acquire the channel access right.

Thereafter, at time t12, the gNB 21 transmits the synchronization signal (Sync signal) to the new AP 31 of the WLAN system 12 by using the acquired resource. Note that the channel access right may be acquired by the WLAN system 12, and in that case, the acquired channel access right is notified to the gNB 21.

The new AP 31 completes the reception of the synchronization signal transmitted from the gNB 21 at time t13, and performs its own DL transmission with the resources of the WLAN system 12 indicated by the synchronization signal (times t12 to t20 of the frequencies f2 to f3 indicated by the thick line) at time t14 after an offset time has elapsed.

When completing the reception of the DL transmission from the new AP 31 at time t17, the new STA 34 transmits an Ack signal at time t18 after a short inter frame space (SIFS) time has elapsed. The new AP 31 completes the reception of the Ack signal transmitted from the new STA 34 at time t19.

Note that the DL transmission of the new AP 31 itself including the reception of the Ack signal is performed with a data length and a modulation and coding scheme that correspond to the allocated resources of the WLAN system 12 (times t14 to t20 of the frequencies f2 to f3).

Furthermore, the DL transmission can be performed a plurality of times as long as the data length and the modulation and coding scheme correspond to the allocated resources of the WLAN system 12. Moreover, the DL transmission signal may include information regarding the WLAN resource indicated by the synchronization signal.

After time t20, the resources become the resources of the cellular system 11.

### <Transmission of Synchronization Signal and UL Transmission of WLAN>

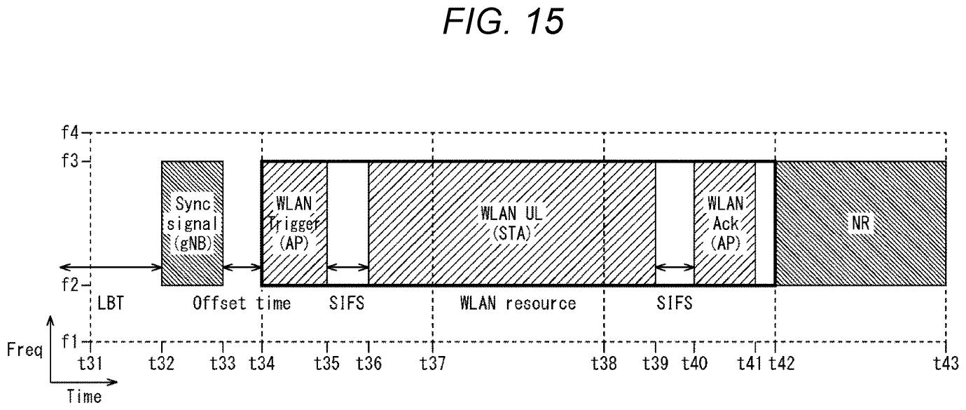

FIG. 15 is a diagram illustrating examples of resources in transmission of the synchronization signal in the wireless communication system and the UL transmission of the WLAN system 12.

Note that, in FIG. 15, description of points similar to those in FIG. 14 will be omitted.

First, the gNB 21 executes LBT at time t31 to acquire the channel access right.

Thereafter, at time t32, the gNB 21 transmits the synchronization signal (Sync signal) to the new AP 31 of the WLAN system 12 by using the acquired resource.

The new AP 31 completes the reception of the synchronization signal transmitted from the gNB 21 at time t33, and transmits the trigger signal for triggering the UL transmission from the subordinate STA with the resources of the WLAN system 12 indicated by the synchronization signal (times t34 to t42 of the frequencies f2 to f3 indicated by the thick line) at time t34 after the offset time has elapsed.

At time t36 after the lapse of an SIFS time from time t35 when the reception of the trigger signal is completed, the destination STA performs the UL transmission. The new AP 31 completes the reception of the signal by the UL transmission from the destination STA at time t39, and transmits the Ack signal at time t40 after the lapse of the SIFS time.

Note that the UL transmission of the subordinate STA including the transmission of the trigger signal and the transmission of the Ack signal is performed with a data length and a modulation and coding scheme that correspond to the allocated resources of the WLAN system 12 (times t34 to t42 of the frequencies f2 to f3).

Furthermore, the UL transmission can be performed a plurality of times as long as the data length and the modulation and coding scheme correspond to the allocated resources of the WLAN system 12.

After time t42, the resources become the resources of the cellular system 11.

### <Frame Format of Synchronization Signal in WLAN Signal Format>

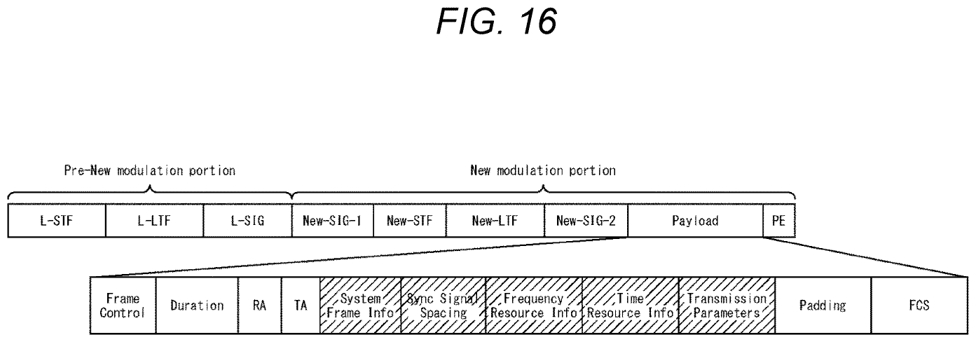

FIG. 16 is a diagram illustrating an example of the frame format of the synchronization signal in the WLAN signal format.

The synchronization signal in FIG. 16 includes a pre-new modulation portion and a new modulation portion. In FIG. 16, characteristic information of the present technology is hatched.

The pre-new modulation portion uses an OFDM signal format of the existing WLAN system, and includes fields of L-STF, L-LTF, and L-SIG.

L-STF and L-LTF include known signal sequences for a device on the reception side to perform frequency offset estimation, timing synchronization, reception gain adjustment, and the like.

L-SIG includes information regarding the length of the synchronization signal and the modulation and coding scheme after this field.

The new modulation portion includes fields of New-SIG-1, New-STF, New-LTF, New-SIG-2, Payload, and Peding (PE).

New-SIG-1 and New-SIG-2 include information regarding various communication parameters of the synchronization signal, for example, information indicating that the information is from the gNB and includes information regarding a system frame.

New-STF and New-LTF include known signal sequences for a device on the reception side to perform frequency offset estimation, timing synchronization, reception gain adjustment, and the like.

Payload includes an information body of the synchronization signal.

PE includes information regarding length adjustment of the synchronization signal.

Payload includes subfields of Frame Control, Dulation/ID, Receiver Address (RA), Transmitter Address (TA), System Frame Info, Sync Signal Spacing, Frequency Resource Info, Time Resource Info, Transmission Parameters, Padding, and FCS.

Frame Control includes information regarding a type of the frame.

Dulation/ID includes information regarding the length of the frame.

RA includes information regarding a transmission destination address of the frame.

TA includes information regarding a transmission source address of the frame.

System Frame Info includes information regarding a system frame defined by the gNB 21. The information regarding the system frame is, for example, information indicating whether the system frame is started from an end timing of the synchronization signal, the SSS or the PSS, or the time information of the GNSS.

Sync Signal Spacing includes information regarding a time interval of the resources (for example, an offset time in FIGS. 14 and 15) between the synchronization signal and the WLAN system 12.

Note that, at that time, Sync Signal Spacing may include an actual time interval or may include an encoding value of the time interval. For example, the time interval of the resources between the synchronization signal and the WLAN system 12 is set to a first time interval in a case where the encoding value is zero, and is set to a second time interval in a case where the encoding value is one.

Furthermore, the time interval of the resources between the synchronization signal and the WLAN system 12 may be set to constant multiplication of a predefined unit time. For example, the predefined unit time is a fixed value, SIFS, a slot of a system frame, or the like. At this time, for example, Sync Signal Spacing includes a constant. For example, in a case where a value of the constant is five, a time interval of the resources between the synchronization signal and the WLAN system 12 is set to 5 times the predefined unit time. Furthermore, for example, the predefined unit time can be constant multiplication of the unit time used in the cellular system 11 or the WLAN system 12.

Note that, in a case where the time interval of the resources between the synchronization signal and the WLAN system 12 is defined in advance, information is not stored in Sync Signal Spacing, or Sync Signal Spacing is omitted.

Frequency Resource Info includes information regarding a frequency of a resource of the WLAN system 12. At that time, Frequency Resource Info is specified with a center frequency and a frequency width. Alternatively, Frequency Resource Info is specified with information indicating that the frequency band is the same as the frequency band used for transmitting the synchronization signal.

Time Resource Info includes information regarding a time of the resource of the WLAN system 12. At that time, Time Resource Info may be, for example, information based on the system frame such as Y slots of the system frame, or may be specifying of a real time. Furthermore, Time Resource Info may be used until the transmission terminal receives the end signal, or may be a prescribed period.

Transmission Parameters includes information regarding a communication parameter of the WLAN system 12. For example, information regarding a specified or recommended modulation and coding scheme, a traffic type, and a traffic direction (UL or DL) may be included.

For example, since it is possible to specify whether or not data requires low latency and high reliability as the traffic type, the data requiring low latency and high reliability can be preferentially transmitted.

Padding includes information regarding adjustment of the length of the frame.

FCS includes information regarding a frame check sequence of the frame.

Note that, in Payload, in the hatched characteristic information of the present technology, System Frame Info, Frequency Resource Info, and Transmission Parameters are optional and can be omitted.

### <Synchronization Signal in NR Signal Format>

Moreover, a case where the synchronization signal is in the NR signal format will be described below. Even when the synchronization signal is the NR signal, only the signal format is different, and the synchronization signal in the NR signal format basically includes information similar to that of the synchronization signal in the WLAN signal format.

The NR signal format is a format similar to the format used by the gNB 21.

In the NR signal format, the synchronization signal and a broadcast channel (SS/PBCH Synchronization signals/physical broadcast channel block) and a control channel (physical downlink control channel (PDCCH)) are transmitted through different channels.

Note that the synchronization signal (Sync signal) illustrated in FIGS. 14 and 15 may be transmitted as a control channel.

The synchronization signal and the broadcast channel are periodically transmitted within a preset time-frequency resource.

At that time, the synchronization signal is a signal including a known sequence similarly to the PSS and the SSS, and is used to notify or acquire information (including transmission channel characteristics) necessary for performing synchronization processing such as symbol synchronization, frame synchronization, and wireless frame synchronization, and demodulating and decoding of the PBCH.

Note that the synchronization signal may be generated from the gNB 21 or may be generated on the basis of Universal Time, Coordinated (UTC) transmitted from GNSS or the like.

The broadcast channel is used to transmit control information common to at least one of a plurality of APs or a plurality of STAs. In the present technology, the control information includes, for example, information regarding a control channel received by at least one of the AP or the STA.

The information regarding the control channel received by at least one of the AP or the STA includes at least one piece of information regarding a time-frequency resource to which the control channel may be transmitted, information necessary for demodulating and decoding the control channel, or information regarding a spatial stream to which the control channel may be mapped.

The control channel is a separate control channel for at least one of the AP or the STA, and is used to transmit control information specific to at least one of the AP or the STA. In the present technology, the control information includes, for example, a part or all of the following pieces of information.

(1) Information regarding a time-frequency resource that can be used by at least one of the AP or the STA in the WLAN. Note that, in the information regarding the time-frequency resource, the information regarding the frequency resource is optional and can be omitted. Furthermore, in this case, not only the information immediately after PDCCH reception but also the information after PDCCH reception can be included, and thus future resource reservation is also possible.

(2) Information regarding a spatial stream that can be used by at least one of the AP or the STA in the WLAN

(3) Information regarding transmission power (maximum transmission power) that can be used by at least one of the AP or the STA in the WLAN

(4) Information regarding at least one of a power detection threshold and a signal detection threshold, which are used by at least one of the AP and the STA in the WLAN at the time of transmission

(5) Information regarding a space reuse parameter used by at least one of the AP or the STA in the WLAN at the time of transmission

(6) Information regarding a priority used when at least one of the AP or the STA in the WLAN preferentially transmits packets

(7) Information regarding a type of frame used by at least one of the AP or the STA of in the WLAN at the time of transmission

(8) Information regarding modulation and coding, and an OFDM signal format used by at least one of the AP or the STA in the WLAN at the time of transmission

(9) Information regarding a padding scheme used by at least one of the AP or the STA in the WLAN at the time of transmission

The above-described pieces of information (2) to (9) are optional and can be omitted.

Note that the transmission parameters such as a subcarrier interval and a guard interval length may be transmitted using the same information as that of the WLAN.

### <Mutual Detection Processing and Connection Establishment Processing>

FIG. 17 is a sequence diagram illustrating mutual detection processing and connection establishment processing of the gNB 21 and the new AP 31.

In step S101, the gNB 21 broadcasts the PSS and the SSS as a whole. The PSS and the SSS may be used as a signal in the existing NR signal format, and may include information indicating that the PSS and the SSS are compatible with the synchronization signal proposed in the present technology in addition to those used as the signal in the existing NR signal format. Furthermore, the PSS and the SSS may be transmitted as the signal in the existing NR signal format, or may be transmitted as the signal in the WLAN signal format including the similar information.

In step S102, the new AP 31 that receives the PSS and the SSS performs an initial access procedure with the gNB 21 and establishes a connection. The initial access procedure may be used for a signal in the existing NR signal format. Furthermore, in a case where the PSS and the SSS are transmitted as signals in the WLAN signal format, the initial access procedure may be omitted.

In step S103, the new AP 31 that has established the connection with the gNB 21 transmits a radio resource control (RRC) signal used by the existing cellular system 11 and including capability information to the gNB 21. The capability information includes information regarding compatibility with the synchronization signal proposed in the present technology and information regarding an execution request for transmission of the synchronization signal proposed in the present technology.

The above-described execution request may include information regarding resources for performing transmission of the synchronization signal proposed in the present technology, and may include, for example, a frequency resource for performing transmission of the synchronization signal. The RRC signal may be transmitted as the signal in the existing NR signal format, or may be transmitted as the signal in the WLAN signal format including the similar information.

In step S104, the gNB 21 that receives the RRC signal transmitted from the new AP 31 determines whether to perform transmission of the synchronization signal proposed in the present technology on the basis of the information included in the RRC signal, stores acceptance or rejection information in the RRC signal, and transmits the RRC signal to the new AP 31.

The RRC signal may be transmitted as the signal in the existing NR signal format, or may be transmitted as the signal in the WLAN signal format including the similar information. In the case of rejection, information regarding a reason for rejection may be included in the RRC signal.

Note that an execution request for the transmission of the RRC signal or the synchronization signal between the gNB 21 and the new AP 31, and exchange of the acceptance or rejection may be performed after the connection establishment. In this case, synchronization setting different from that at the time of the connection establishment may be performed.

As described above, in the present technology, the gNB 21 transmits the synchronization signal in the WLAN signal format or a gNB signal format to at least one of the new AP 31 or the new STA 33.

Thus, at least one of the new AP 31 or the new STA 33 can obtain the allocation of the system frame and WLAN resource determined by the gNB 21. Therefore, communication collision between the cellular system 11 and the WLAN system 12 can be reduced, WLAN and NR coexist in the unlicensed band, and various communication indexes can be optimized in the entire wireless communication system.

Furthermore, in the present technology, the resources of the system frame are notified with any one of the synchronization signal, the synchronization signal (SSS or PSS) of the gNB, and time information based on the GNSS as a starting point.

Thus, it is possible to notify the resources of the system frame regardless of the function of the WLAN system 12 (whether or not the SSS or the PSS can be received or the GNSS is mounted).

In the present technology, the WLAN resource is notified by specifying the time information after a certain period time of notification of the synchronization signal based on the system frame.

Thus, it is possible to flexibly notify the WLAN resource.

### 4. Others

### <Effects of Present Technology>

As described above, in the new AP or the new STA of the WLAN system of the present technology, information regarding a communication resource usable by the new AP or the new STA is acquired, the information being determined on the basis of the transmission information (first synchronization signal) transmitted from another first wireless communication device (gNB) of another bidirectional second communication system (cellular system) different from a first communication system (WLAN system) of the new AP or the new STA.

Therefore, the new AP or the new STA of the WLAN system can grasp the resources specified by the gNB.

Thus, various indexes can be optimized in the entire wireless communication system while the WLAN system and the cellular system coexist in the unlicensed band.

### Configuration Example of Computer

The series of processing described above can be executed by hardware or by software. In a case where the series of processing is executed by software, a program included in the software is installed from a program recording medium to a computer incorporated in dedicated hardware, a general-purpose personal computer, or the like.

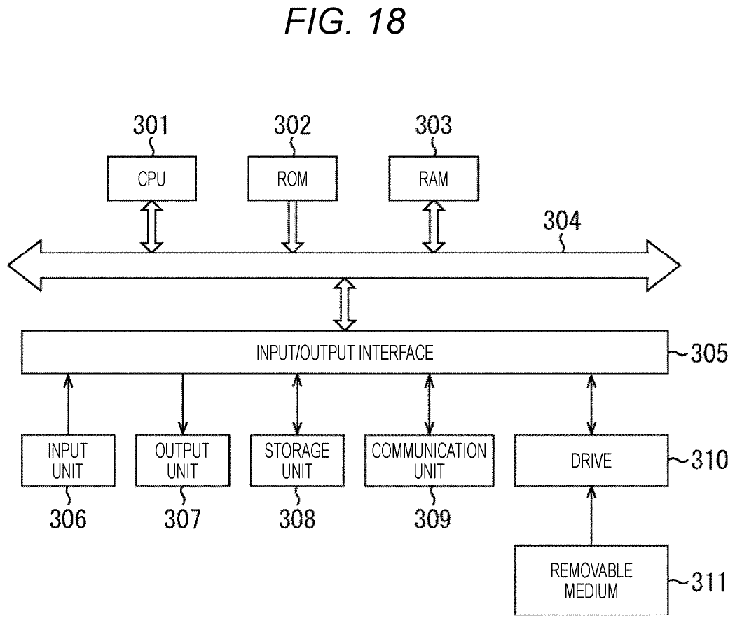

FIG. 18 is a block diagram illustrating a configuration example of the hardware of the computer that executes the series of processing described above according to the program.

A central processing unit (CPU) 301, a read only memory (ROM) 302, and a random access memory (RAM) 303 are mutually connected by a bus 304.

Moreover, an input/output interface 305 is connected to the bus 304. An input unit 306 including a keyboard and a mouse, and an output unit 307 including a display and a speaker are connected to the input/output interface 305. Furthermore, the input/output interface 305 is connected to a storage unit 308 including a hard disk and a non-volatile memory, a communication unit 309 including a network interface, and a drive 310 that drives a removable medium 311.

In the computer configured as described above, for example, the CPU 301 loads a program stored in the storage unit 308 into the RAM 303 via the input/output interface 305 and the bus 304, and executes the program to perform the above-described series of processing.

The program to be executed by the CPU 301 is provided, for example, by being recorded on the removable medium 311 or via a wired or wireless transmission medium such as a local area network, the Internet, or digital broadcasting, and is installed in the storage unit 308.

Note that the program executed by the computer may be the program of which the processing are performed in chronological order in the order described in this description or may be the program of which the processing are performed in parallel or at required timing such as when a call is issued.

### Application Examples

The present technology can be applied to various products. For example, the wireless communication device 51 in FIG. 2 may be implemented as a mobile terminal such as a smartphone, a tablet personal computer (PC), a notebook PC, a portable game terminal, or a digital camera, a fixed terminal such as a television receiver, a printer, a digital scanner, or a network storage, or an in-vehicle terminal such as a car navigation device. Furthermore, the wireless communication device 51 may be implemented as a machine to communication (MaM) terminal such as a smart meter, a vending machine, a remote monitoring device, or a point of sale (POS) terminal. Moreover, the wireless communication device 51 may be a wireless communication module (for example, an integrated circuit module configured with one die) mounted on these terminals.

On the other hand, for example, the wireless communication device 51 may be implemented as a wireless LAN AP (wireless base station) having a router function or not having the router function. Furthermore, the wireless communication device 51 may be implemented as a mobile wireless LAN router. Moreover, the wireless communication device 51 may be a wireless communication module (for example, an integrated circuit module configured with one die) mounted on these terminals.

### Configuration Example of Smartphone

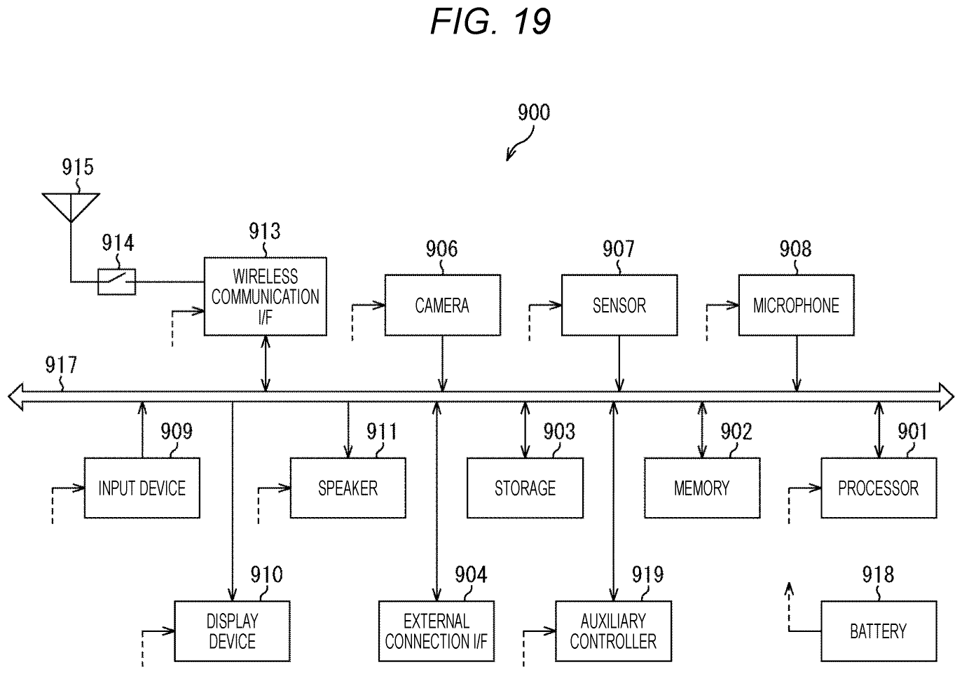

FIG. 19 is a block diagram illustrating a schematic configuration example of the smartphone to which the present technology is applied.

A smartphone 900 includes a processor 901, a memory 902, a storage 903, an external connection interface 904, a camera 906, a sensor 907, a microphone 908, an input device 909, and a display device 910. Furthermore, the smartphone 900 includes a speaker 911, a wireless communication interface 913, an antenna switch 914, an antenna 915, a bus 917, a battery 918, and an auxiliary controller 919.

The processor 901 may be, for example, a CPU or a system on chip (SoC), and restricts functions of an application layer and other layers of the smartphone 900.

The memory 902 includes a RAM and a ROM, and stores a program to be executed by the processor 901, and data.

The storage 903 may include a storage medium such as a semiconductor memory or a hard disk.

The external connection interface 904 is an interface for connecting an external device such as a memory card or a universal serial bus (USB) device to the smartphone 900.

The camera 906 includes an imaging element such as, for example, a charge coupled device (CCD) or a complementary mental oxide semiconductor (CMOS), and generates a captured image.

The sensor 907 may include, for example, a sensor group including a positioning sensor, a gyro sensor, a geomagnetic sensor, and an acceleration sensor.

The microphone 908 converts audio inputted to the smartphone 900 into an audio signal.

The input device 909 includes, for example, a touch sensor that detects a touch on a screen of the display device 910, a keypad, a keyboard, a button, and a switch, and receives an operation by the user or information inputted from the user.

The display device 910 has a screen such as a liquid crystal display (LCD) or an organic light emitting diode (OLED) display, and converts the audio signal output from the smartphone 900 into audio.

The wireless communication interface 913 supports one or more of wireless LAN standards such as IEEE 802.11a, 11b, 11g, 11ac, and 11ad, and performs wireless communication.

The wireless communication interface 913 communicates with other devices via the wireless LAN AP in an infrastructure mode. Furthermore, the wireless communication interface 913 directly communicates with other devices in an ad hoc mode or a direct communication mode such as Wi-Fi Direct.

Note that, in Wi-Fi Direct, unlike the ad hoc mode, one of two terminals operates as an AP, but communication is directly performed between the terminals.

The wireless communication interface 913 typically includes a baseband processor, a radio frequency (RF) circuit, and a power amplifier. The wireless communication interface 913 may be a one-chip module in which a memory that stores a communication control program, a processor that executes the program, and related circuits are integrated.

In addition to the wireless LAN scheme, the wireless communication interface 913 may support other types of wireless communication schemes such as a short-range wireless communication scheme, a proximity wireless communication scheme, and a cellular communication scheme.

The antenna switch 914 switches a connection destination of the antenna 915 among a plurality of circuits (for example, circuits for different wireless communication schemes) included in the wireless communication interface 913.

The antenna 915 has a single or a plurality of antenna elements (for example, a plurality of the antenna elements forming a multiple input multiple output (MIMO) antenna), and is used for transmission and reception of a wireless signal by the wireless communication interface 913.

Note that the smartphone 900 is not limited to the example of FIG. 19, and may include a plurality of the antennas (for example, a wireless LAN antenna, an antenna of a proximity wireless communication scheme, and the like). In that case, the antenna switch 914 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the wireless communication interface 913, and the auxiliary controller 919 to one another.

The battery 918 supplies power to each block of the smartphone 900 illustrated in FIG. 19 through a feed line partially illustrated by a broken line in FIG. 19. The auxiliary controller 919 causes operation of minimum necessary functions of the smartphone 900, for example, in a sleep mode.

In the smartphone 900 illustrated in FIG. 19, the communication control unit 85 described above with reference to FIG. 2 may be implemented in the wireless communication interface 913. Furthermore, at least some of these functions may be implemented in the processor 901 or the auxiliary controller 919.

Note that the smartphone 900 may operate as a wireless AP (software AP) when the processor 901 executes an AP function at an application level. Furthermore, the wireless communication interface 913 may have the wireless AP function.

Moreover, the smartphone 900 may include a biometric authentication unit (fingerprint authentication, palm-shape authentication, voice authentication, blood vessel authentication, face authentication, iris authentication, and retina authentication). At that time, the wireless communication interface 913 in which the communication control unit 85 described above with reference to FIG. 2 is implemented is configured to receive power supply from the same battery 918 as at least one of the display device 910, the speaker 911, or the biometric authentication unit.

Furthermore, in the smartphone 900, information is displayed from at least one of the display device 910 or the speaker 911 on the basis of communication with an external device through the wireless communication interface 913. At that time, a result of synchronization according to the present technology may be output as information from at least one of the display device 910 or the speaker 911.

### Configuration Example of In-Vehicle Device

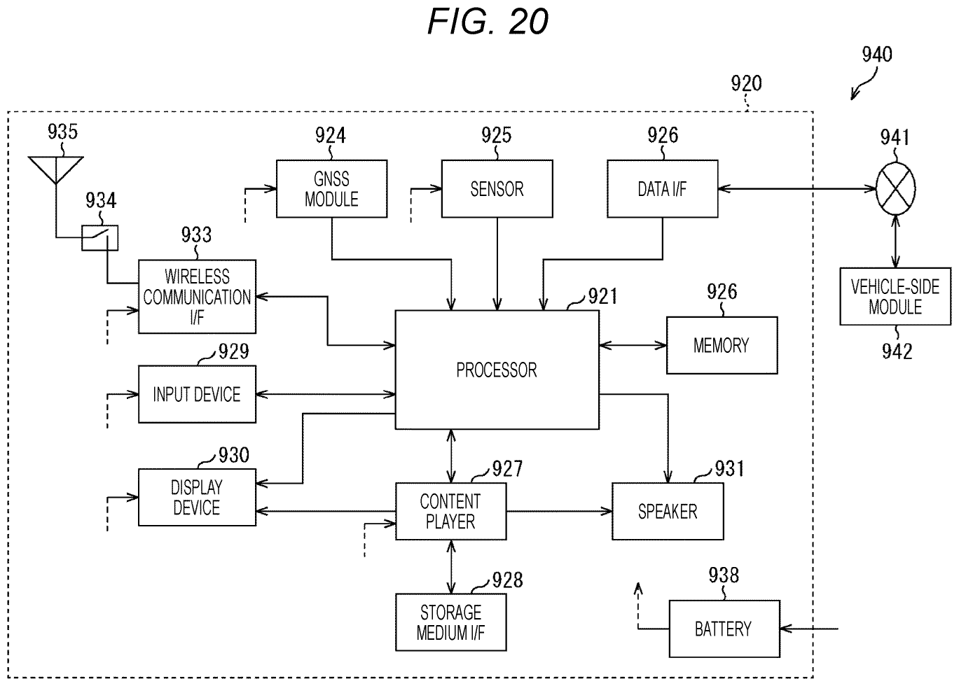

FIG. 20 is a block diagram illustrating a schematic configuration example of an in-vehicle device 920 to which the present technology is applied.

The in-vehicle device 920 includes a processor 921, a memory 922, a GNSS module 924, a sensor 925, a data interface 926, a content player 927, and a storage medium interface 928. Furthermore, the in-vehicle device 920 includes an input device 929, a display device 930, a speaker 931, a wireless communication interface 933, an antenna switch 934, an antenna 935, and a battery 938.

The processor 921 may be, for example, a CPU or an SoC, and controls a navigation function and other functions of the in-vehicle device 920. Furthermore, the processor 921 can also control a drive system of a vehicle, such as a brake, an accelerator, or a steering, on the basis of information obtained through communication based on the present technology.

The memory 922 includes a RAM and a ROM, and stores a program to be executed by the processor 921, and data.

The GNSS module 924 uses a GNSS signal received from a GNSS satellite to measure a location (for example, latitude, longitude, and altitude) of the in-vehicle device 920.

The sensor 925 includes, for example, a sensor group including a gyro sensor, a geomagnetic sensor, and an air pressure sensor.

The data interface 926 is connected to an in-vehicle network 941 via, for example, a terminal (not shown), and acquires data generated on the vehicle side, such as in-vehicle data.

The content player 927 plays contents stored in a storage medium (for example, a CD or a DVD) inserted into the storage medium interface 928.

The input device 929 includes, for example, a touch sensor that detects a touch on a screen of the display device 930, a button, a switch, or the like, and receives an operation by the user or an information input from the user.

The display device 930 has a screen such as an LCD or an OLED display, and displays an image of a navigation function or played contents.

The speaker 931 outputs sound of the navigation function or played contents.

Note that, in the in-vehicle device 920, the navigation function and the function of the content player 927 are optional. The navigation function and the content player 927 may be removed from the configuration of the in-vehicle device 920.

The wireless communication interface 933 supports one or more of wireless LAN standards such as IEEE 802.11a, 11b, 11g, 11n, 11ac, and 11ad, and performs wireless communication. The wireless communication interface 933 communicates with other devices via the wireless LAN AP in the infrastructure mode. Furthermore, the wireless communication interface 933 directly communicates with other devices in an ad hoc mode or a direct communication mode such as Wi-Fi Direct.

The wireless communication interface 933 typically includes a baseband processor, a RF circuit, and a power amplifier. The wireless communication interface 933 may be a one-chip module in which a memory that stores a communication control program, a processor that executes the program, or related circuits are integrated. In addition to the wireless LAN scheme, the wireless communication interface 933 may support other types of wireless communication schemes such as a short-range wireless communication scheme, a proximity wireless communication scheme, and a cellular communication scheme.

The antenna switch 934 switches a connection destination of the antenna 935 among a plurality of circuits included in the wireless communication interface 933.

The antenna 935 has a single or a plurality of antenna elements, and is used for transmission and reception of the wireless signal through the wireless communication interface 933.

Note that the in-vehicle device 920 is not limited to the example of FIG. 20, and may include a plurality of the antennas 935. In that case, the antenna switch 934 may be omitted from the configuration of the in-vehicle device 920.

The battery 938 may supply power through a feed line partially illustrated by a broken line in FIG. 20, and in the in-vehicle device 920 illustrated in FIG. 20, the communication control unit 85 described with reference to FIG. 2 may be mounted in the wireless communication interface 933. Furthermore, at least some of these functions may be implemented in the processor 921.

Furthermore, the wireless communication interface 933 may operate as the wireless communication device 51 described above and provide wireless connection to a terminal possessed by a user in the vehicle.

Furthermore, the present technology may be implemented as an in-vehicle system (or vehicle) 940 including one or more blocks of the in-vehicle device 920 described above, the in-vehicle network 941, and a vehicle-side module 942. The vehicle-side module 942 generates vehicle-side data such as a vehicle speed, an engine speed, or failure information, and outputs the generated data to the in-vehicle network 941.

### Configuration Example of Wireless AP

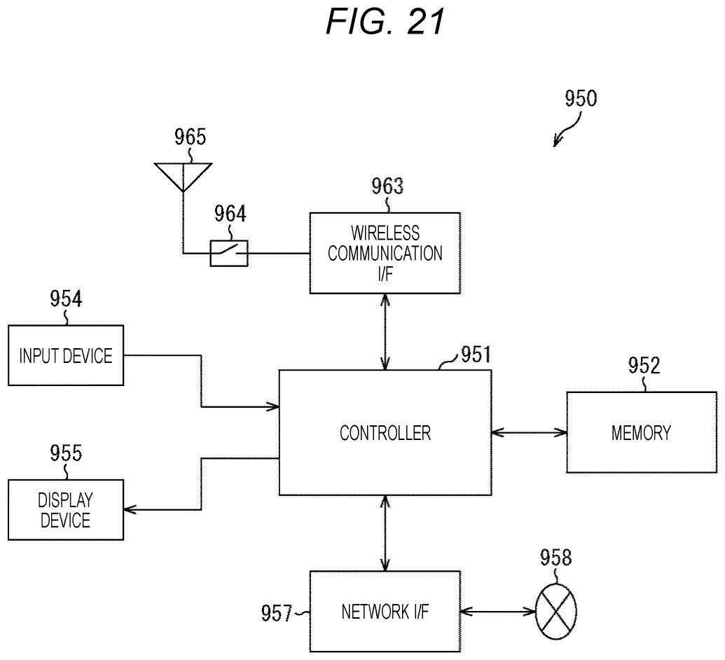

FIG. 21 is a block diagram illustrating a schematic configuration example of a wireless AP 950 to which the present technology is applied.

The wireless AP 950 includes a controller 951, a memory 952, an input device 954, a display device 955, a network interface 957, a wireless communication interface 963, an antenna switch 964, and an antenna 965.

The controller 951 may be, for example, a CPU or a digital signal processor (DSP), and operates various functions (for example, access restriction, routing, encryption, firewall, log management, and the like) of an Internet protocol (IP) layer and higher layer of the wireless AP 950.

The memory 952 includes a RAM and a ROM, and stores a program to be executed by the controller 951 and various control data (for example, a terminal list, a routing table, an encryption key, a security setting, a log, and the like).

The input device 954 includes, for example, a button and a switch, and receives an operation from the user.

The display device 955 includes an LED lamp, and displays an operation status of the wireless AP 950.

The network interface 957 is a wired communication interface for connecting the wireless AP 950 to a wired communication network 958. The network interface 957 may have a plurality of connection terminals. The wired communication network 958 may be a LAN such as Ethernet (registered trademark), or may be a wide area network (WAN).

The wireless communication interface 963 supports one or more of wireless LAN standards such as IEEE 802.11a, 11b, 11g, 11n, 11ac, and 11ad, and provides wireless connection as an AP to a nearby terminal.

The wireless communication interface 963 typically includes a baseband processor, a RF circuit, and a power amplifier.

The wireless communication interface 963 may be a one-chip module in which a memory that stores a communication control program, a processor that executes the program, or related circuits are integrated.

The antenna switch 964 switches a connection destination of the antenna 965 among a plurality of circuits included in the wireless communication interface 963, and the antenna 965 has a single or a plurality of antenna elements and is used for transmission and reception of the wireless signal through the wireless communication interface 963.

In the wireless AP 950 illustrated in FIG. 21, the communication control unit 85 described above with reference to FIG. 2 may be implemented in the wireless communication interface 963. Furthermore, at least some of these functions may be implemented in the controller 951.

Note that, the above-described embodiments describe an example for embodying the present technology, and there is a correspondence relationship between the matters in the embodiments and the matters specifying the invention in claims. Similarly, there is a correspondence relationship between the matters specifying the invention in claims and the matters in the embodiments of the present technology having the same names. However, the present technology is not limited to the embodiments, and can be embodied by applying various modifications to the embodiments without departing from the gist of the present technology.

Furthermore, the procedures described in the above-described embodiment may be considered as a method including a series of procedures and may be considered as a program for causing this computer to execute the series of procedures and a recording medium which stores the program.

As this recording medium, for example, a compact disc (CD), a MiniDisc (MD), a digital versatile disc (DVD), a memory card, a Blu-ray (registered trademark) disc, and the like can be used.

Note that, in the present description, a system means an assembly of a plurality of components (devices, modules (parts), and the like), and it does not matter whether or not all the components are located in the same housing. Therefore, a plurality of devices housed in separate housings and coupled via a network and one device in which a plurality of modules is housed in one housing are both systems.

Furthermore, the effects described in the present description are merely examples and not restrictive, and there may also be other effects.

Embodiments of the present technology are not limited to the above-described embodiments, and various modifications may be made without departing from the gist of the present technology.

For example, the present technology may be configured as cloud computing in which one function is shared by a plurality of devices via a network and processing is executed in cooperation.

Furthermore, each step described in the flowchart described above can be performed by one device or by a plurality of devices in a shared manner.

Moreover, in a case where a plurality of processing is included in one step, a plurality of the processing included in the one step can be performed by one device or by a plurality of devices in a shared manner.

### Example of Configuration Combination

The present technology can also be configured as follows.

(1)

A wireless communication device including
a communication control unit configured to acquire information regarding a communication resource usable by the wireless communication device, the information being determined on the basis of transmission information transmitted from another first wireless communication device of another bidirectional second communication system different from a first communication system of the wireless communication device.
   (2)

The wireless communication device according to (1), in which
the transmission information includes a first synchronization signal.
   (3)

The wireless communication device according to (2), in which
the communication resource is a time resource.
   (4)

The wireless communication device according to (3), in which
the communication resource is a system frame.
   (5)

The wireless communication device according to (4), in which
the system frame starts from the first synchronization signal, a second synchronization signal that is different from the first synchronization signal and is used by the second communication system, or time information of a global navigation satellite system (GNSS).
   (6)

The wireless communication device according to any one of (2) to (5), in which
the information regarding the communication resource includes information regarding time intervals between the first synchronization signal and the communication resource.
   (7)

The wireless communication device according to any one of (2) to (6), in which
the information regarding the communication resource includes information regarding a time of the communication resource.
   (8)

The wireless communication device according to any one of (2) to (7), in which
the information regarding the communication resource includes information regarding a frequency of the communication resource.
   (9)

The wireless communication device according to any one of (2) to (8), in which
the first synchronization signal includes information regarding a communication parameter of the first communication system.
   (10)

The wireless communication device according to (9), in which
the information regarding the communication parameter includes information specifying a traffic type.
   (11)

The wireless communication device according to any one of (2) to (10), in which
the communication control unit starts communication in the first communication system on the basis of the information regarding the communication resource.
   (12)

The wireless communication device according to (11), in which
the communication control unit starts communication in the first communication system on the basis of a trigger signal transmitted from another second wireless communication device to which the wireless communication device is connected in the first communication system.
   (13)

The wireless communication device according to (11), in which
the communication control unit starts communication in the first communication system by the wireless communication device starting transmission or by triggering transmission of another second wireless communication device in the first communication system.
   (14)

The wireless communication device according to (13), in which
the communication control unit notifies the another second wireless communication device in the first communication system of the information regarding the communication resource.
   (15)

The wireless communication device according to (13), in which
the communication control unit converts the first synchronization signal generated in a signal format used by the second communication system into the first synchronization signal in a signal format used by the first communication system.
   (16)

The wireless communication device according to any one of (1) to (15), in which
the first communication system is a wireless local area network (WLAN) system, and
the second communication system is a cellular system.
   (17)

A wireless communication method including,
by a wireless communication device,
acquiring information regarding a communication resource usable by the wireless communication device, the information being determined on the basis of transmission information transmitted from another wireless communication device of another bidirectional second communication system different from a first communication system of the wireless communication device.
   (18)

A program causing a computer to function as
a communication control unit configured to acquire information regarding a communication resource usable by a wireless communication device, the information being determined on the basis of transmission information transmitted from another wireless communication device of another bidirectional second communication system different from a first communication system of the wireless communication device.
   (19)

A wireless communication device including
a communication control unit configured to perform control to transmit, to another wireless communication device of another bidirectional second communication system, transmission information determined on the basis of the transmission information transmitted from a first communication system of the wireless communication device, the transmission information including information regarding a communication resource usable by the another wireless communication device of the second communication system.
   (20)

The wireless communication device according to (19), in which
the transmission information includes a first synchronization signal.
   (21)

The wireless communication device according to (20), in which
the communication resource is a time resource.
   (22)

The wireless communication device according to (21), in which
the communication resource is a system frame.
   (23)

The wireless communication device according to (22), in which
the system frame starts from the first synchronization signal, a second synchronization signal that is different from the first synchronization signal and is used by the second communication system, or time information of a global navigation satellite system (GNSS).
   (24)

The wireless communication device according to any one of (20) to (23), in which
the information regarding the communication resource includes information regarding time intervals between the first synchronization signal and the communication resource.
   (25)

The wireless communication device according to any one of (20) to (24), in which
the information regarding the communication resource includes information regarding a time of the communication resource.
   (26)

The wireless communication device according to any one of (20) to (25), in which
the information regarding the communication resource includes information regarding a frequency of the communication resource.
   (27)

The wireless communication device according to any one of (20) to (26), in which
the first synchronization signal includes information regarding a communication parameter of the first communication system.
   (28)

The wireless communication device according to (27), in which
the information regarding the communication parameter includes information specifying a traffic type.
   (29)

The wireless communication device according to any one of (20) to (28), in which
the communication control unit converts the first synchronization signal generated in a signal format used by the first communication system into a signal format used by the second communication system.
   (30)

The wireless communication device according to any one of (19) to (29), in which
the first communication system is a cellular system, and
the second communication system is a wireless local area network (WLAN) system.
   (31)

A wireless communication method including,
by a wireless communication device,
performing control to transmit, to another wireless communication device of another bidirectional second communication system, transmission information determined on the basis of the transmission information transmitted from a first communication system of the wireless communication device, the transmission information including information regarding a communication resource usable by the another wireless communication device of the second communication system.
   (32)

A program causing a computer to function as
a communication control unit configured to perform control to transmit transmission information determined on the basis of the transmission information transmitted from a first communication system of a wireless communication device to another wireless communication device of another bidirectional second communication system, the transmission information including information regarding a communication resource usable by the another wireless communication device of the second communication system.

### REFERENCE SIGNS LIST

1 Wireless communication system
11 Cellular system
12 WLAN system
21 gNB
22 UE
31 New AP
32 Legacy AP
33 New STA
34, 34-1, 34-2 Legacy STA
51 Wireless communication device
61 Communication unit
85 Communication control unit
86 Communication storage unit

1. A wireless communication device comprising
a communication control unit configured to acquire information regarding a communication resource usable by the wireless communication device, the information being determined on a basis of transmission information transmitted from another first wireless communication device of another bidirectional second communication system different from a first communication system of the wireless communication device.

2. The wireless communication device according to claim 1, wherein
the transmission information includes a first synchronization signal.

3. The wireless communication device according to claim 2, wherein
the communication resource is a time resource.

4. The wireless communication device according to claim 3, wherein
the communication resource is a system frame.

5. The wireless communication device according to claim 4, wherein
the system frame starts from the first synchronization signal, a second synchronization signal that is different from the first synchronization signal and is used by the second communication system, or time information of a global navigation satellite system (GNSS).

6. The wireless communication device according to claim 2, wherein
the information regarding the communication resource includes information regarding time intervals between the first synchronization signal and the communication resource.

7. The wireless communication device according to claim 2, wherein
the information regarding the communication resource includes information regarding a time of the communication resource.

8. The wireless communication device according to claim 2, wherein
the information regarding the communication resource includes information regarding a frequency of the communication resource.

9. The wireless communication device according to claim 2, wherein the first synchronization signal includes information regarding a communication parameter of the first communication system.

10. The wireless communication device according to claim 9, wherein
the information regarding the communication parameter includes information specifying a traffic type.

11. The wireless communication device according to claim 2, wherein
the communication control unit starts communication in the first communication system on a basis of the information regarding the communication resource.

12. The wireless communication device according to claim 11, wherein
the communication control unit starts communication in the first communication system on a basis of a trigger signal transmitted from another second wireless communication device to which the wireless communication device is connected in the first communication system.

13. The wireless communication device according to claim 11, wherein
the communication control unit starts communication in the first communication system by the wireless communication device starting transmission or by triggering transmission of another second wireless communication device in the first communication system.

14. The wireless communication device according to claim 13, wherein
the communication control unit notifies the another second wireless communication device in the first communication system of the information regarding the communication resource.

15. The wireless communication device according to claim 13, wherein the communication control unit converts the first synchronization signal generated in a signal format used by the second communication system into the first synchronization signal in a signal format used by the first communication system.

16. The wireless communication device according to claim 1, wherein
the first communication system is a wireless local area network (WLAN) system, and
the second communication system is a cellular system.

17. A wireless communication method comprising,
by a wireless communication device,
acquiring information regarding a communication resource usable by the wireless communication device, the information being determined on a basis of transmission information transmitted from another wireless communication device of another bidirectional second communication system different from a first communication system of the wireless communication device.

18. A program causing a computer to function as
a communication control unit configured to acquire information regarding a communication resource usable by a wireless communication device, the information being determined on a basis of transmission information transmitted from another wireless communication device of another bidirectional second communication system different from a first communication system of the wireless communication device.

19. A wireless communication device comprising
a communication control unit configured to perform control to transmit transmission information determined on a basis of the transmission information transmitted from a first communication system of the wireless communication device to another wireless communication device of another bidirectional second communication system, the transmission information including information regarding a communication resource usable by the another wireless communication device of the second communication system.

20. A wireless communication method comprising,
by a wireless communication device,
performing control to transmit transmission information determined on a basis of the transmission information transmitted from a first communication system of the wireless communication device to another wireless communication device of another bidirectional second communication system, the transmission information including information regarding a communication resource usable by the another wireless communication device of the second communication system.
